(19) United States
(12) Patent Application Publication
(10) Pub. No.: US 2025/0095934 A1
(43) Pub. Date: Mar. 20, 2025

(54) PROTECTING DEVICE AND BATTERY PACK

(71) Applicant: DEXERIALS CORPORATION, Tochigi (JP)

(72) Inventor: Yuji KIMURA, Tochigi (JP)

(73) Assignee: DEXERIALS CORPORATION, Tochigi (JP)

(21) Appl. No.: 18/729,515

(22) PCT Filed: Dec. 26, 2022
(86) PCT No.: PCT/JP2022/048059

§ 371 Date: Jul. 17, 2024

(30) Foreign Application Priority Data
Jan. 20, 2022 (JP) 2022-007498

(51) Int. Cl. H01H 37/76; H01M 50/204; H01M 50/583

(52) U.S. Cl. CPC H01H 37/761; H01M 50/204; H01M 50/583; H01M 2200/103

(57) ABSTRACT

Even when the blowing member generates heat over a long period of time, the fixing state of the blowing member is stabilized and the current path is interrupted safely and quickly. A protecting device 1 includes a case 28, a fuse element 2, a blowing member 3 connected to at least one side of the fuse element 2 to blow the fuse element 2,a fixing member 8 provided on an inner surface of the case 28 and in contact with the blowing member 3 to suppress the wobbling of the blowing member 3, the blowing member 3 has an insulating substrate 4 and a heat generator 5 formed on the insulating 10 substrate 4, and the insulating substrate 4 is connected to the fuse element 2 by a bonding material 9 that is softened by the heat generated by the heat generator 5.

### TECHNICAL FIELD

This technology relates to a protecting device for interrupting a current path and a battery pack using the same. This application claims priority based on JP 2022-007498 filed in Japan on Jan. 20, 2022, which is hereby incorporated by reference.

### BACKGROUND ART

Secondary batteries are often provided to users in the form of rechargeable battery packs which can be repeatedly used. In particular, in order to protect users and electronic appliances, lithium ion secondary batteries having a high volumetric energy density typically include several protective circuits incorporated in battery packs for over-charging protection and over-discharging protection to interrupt the output of the battery pack under predetermined conditions.

Many electronic devices using lithium-ion rechargeable batteries use an FET switch incorporated in a battery pack to turn ON/OFF the output, for over-charging protection or over-discharging protection of the battery pack. However, even in the cases of the FET switch being short-circuited and damaged for some reason, a large current caused by a surge such as lighting momentarily flowing, or an abnormally decreased output voltage or an excessively high output voltage occurring in an aged battery cell, the battery pack or the electronic appliance should prevent accidents including fire, among others. For this reason, a protective element is used having a fuse device that interrupts a current path in accordance with an external signal so as to safely interrupt the output of the battery cell under these possible abnormalities.

As a protecting device in the protecting circuit for lithium-ion secondary batteries and the like, a structure having a heat generator inside the protecting device is used which blows out the meltable conductor on the current path by the heat generated by the heat generator.

Applications of lithium-ion rechargeable batteries have been expanding in recent years, and they are beginning to be used in larger current applications, such as electric power tools such as electric drivers, and transportation equipment such as hybrid cars, electric cars, and electrically power-assisted bicycles, and drones. In these applications, particularly at startup, a large current exceeding several tens to a hundred Ampere may flow. It is desired to implement a protecting device compatible with such a large current capacity.

In order to implement a protecting device compatible with such a large current, there is proposed a protecting device including a meltable conductor having an increased sectional area and an insulating substrate having a heat generator formed thereon and connected to a surface of the meltable conductor.

FIG. 27 is a plan view of a conventional protecting device, FIG. 28 is a cross-sectional view taken along line D-D′ of FIG. 27, and FIG. 29 is a cross-sectional view taken along line E-E′ of FIG. 27. The protecting device 100 shown in FIGS. 27 to 29 includes a fuse element 101 and a pair of blowing members 102 that blow the fuse element 101.

FIG. 30 shows the blowing members, in which FIG. 30A is a plan view of the front surface of an insulating substrate with a heat generator and FIG. 30B is a bottom view of the back surface of the insulating substrate in contact with the fuse element 101. Each blowing member 102 includes an insulating substrate 103, a heat generator 104 formed on the front surface of the insulating substrate 103, an insulating layer 105 covering the heat generator 104, a heat-generator lead-out electrode 106 connected to the heat generator 104 and superimposed with the heat generator 104 through the insulating layer 105, a holding electrode 107 formed on the back surface of the insulating substrate 103 which holds the melted conductor of the fuse element 101 when the fuse element 101 is blown, and a through-hole 108 that penetrates through the insulating substrate 103 and connects the heat-generator lead-out electrode 106 and the holding electrode 107.

The heat generator 104 is connected at one end to the heat-generator feeding electrode 110. The heat-generator feeding electrode 110 is connected to an external connection electrode 110a formed on the back surface of the insulating substrate 103 via castellation. As shown in FIG. 29, the external connection electrode 110a is connected to the third electrode terminal 113 by a bonding material such as solder paste 114. The heat generator 104 is connected to an external circuit with a power supply via the heat-generator feeding electrode 110, the external connection electrode 110a, and the third electrode terminal 113 and can be powered by the external circuit.

The fuse element 101 is connected to the first and second electrode terminals 111, 112 connected to the external circuit by a bonding material such as the solder paste 114. The fuse element 101 is also connected to the holding electrode 107 and the auxiliary electrode 109 formed on the back surface of the insulating substrate 103 by a bonding material such as the solder paste 114.

In the blowing member 102, when the heat generator 104 is energized and heated, the fuse element 101 is melted by this heat and sucks the melted conductor 101a through the through-hole 108 to the heat-generator lead-out electrode 106 side. As a result, the fuse element 101 is blown between the holding electrode 107 and the auxiliary electrode 109, thereby interrupting the conduction between the first and second electrode terminals 111 and 112.

### CITATION LIST

### Patent Literature

Patent Document 1: JP 2021-34362 A

### SUMMARY OF INVENTION

### Technical Problem

In conventional structures such as the protecting device 100, when used in protection circuits for high-voltage, high-current applications such as electric vehicles, a fuse element 101 with a wide cross-sectional area and increased volume to accommodate large currents is used. When the protecting device 100 works, a high voltage is applied to the heat generator 104 to generate high heat to blow the fuse element 101, but the blowing takes a long time for the volume-increased fuse element 101. The extended heating time by the heat generator 104 accumulates excess heat in the insulating substrate 103. As a result, the fixing state of the blowing member 102, which is fixed to the front and back surfaces of the fuse element 101 by the solder paste 114 tends to become unstable.

For example, as shown in FIG. 31, if the insulating substrate 103 of the blowing member 102 is tilted and the holding electrode 107, which was in surface contact with the front and back surfaces of the fuse element 101, detaches from the fuse element 101, the heat from the heat generator 104 cannot be transferred to the fuse element 101, which may prevent blowing and cause an uncut condition (FIG. 32).

Therefore, an object of the present technology is to provide a protecting device capable of stabilizing the fixing state of the blowing member and safely and quickly interrupting the current path even when the blowing member generates heat over a long period of time, and a battery pack using the protecting device.

### Solution to Problem

In order to solve the above-described problems, a protecting device of the present technology includes: a case; a fuse element; a blowing member connected to at least one side of the fuse element to blow the fuse element; and a fixing member provided on an inner surface of the case and in contact with the blowing member to restrain the wobbling of the blowing member, wherein the blowing member includes an insulating substrate and a heat generator formed on the insulating substrate, and the insulating substrate is connected to the fuse element by a bonding material that is softened by the heat generated by the heat generator.

A battery pack according to the present technology includes one or more battery cells and a protecting device connected on the charging/discharging path of the battery cells to interrupt the charging/discharging path, and the protecting device is the protecting device described above.

### ADVANTAGEOUS EFFECTS OF INVENTION

According to the present technology, a fixing member is provided on the inner surface of the case, and this fixing member contacts the blowing member to suppress the wobbling of the blowing member. As a result, the tilting of the insulating substrate can be suppressed even when the bonding material softens and the fixing state of the blowing member to the fuse element becomes unstable. Therefore, the fixing state of the blowing member can be stabilized, the heat generated by the heat generator can be transferred to the fuse element reliably, and the current path can be interrupted safely and quickly.

### BRIEF DESCRIPTION OF DRAWINGS

FIG. 1 is a plan view of a protecting device according to the present technology.

FIG. 2 is a cross-sectional view of the protecting device taken along line D-D′ shown in FIG. 1.

FIG. 3 is a cross-sectional view of the protecting device taken along line E-E′ shown in FIG. 1.

FIG. 4 shows a blowing member, in which FIG. 4A is a plan view of the front surface of the insulating substrate, and FIG. 4B is a bottom view of the back surface of the insulating substrate.

FIG. 5 shows the state in which the fuse element is melted in the protecting device, in which FIG. 5A is a plan view of the surface of the insulating substrate, and FIG. 5B is a plan view of the back surface of the insulating substrate and the blown fuse element.

FIG. 6 shows the state in which the fuse element is blown in the protecting device according to the present technology, in which, FIG. 6A is a cross-sectional view taken along line A-A′ of the blowing member shown in FIG. 5, and FIG. 6B is a cross-sectional view taken along line B-B′ of the blowing member shown in FIG. 5.

FIG. 7 shows the upper case and the lower case, in which FIG. 7A is a plan view of the upper case, FIG. 7B is a plan view of the lower case, FIG. 7C is a cross-sectional view taken along line F-F′ of the upper case shown in FIG. 7A, and FIG. 7D is a cross-sectional view taken along line G-G′ of the lower case shown in FIG. 7B.

FIG. 8 is a plan view of the lower case supporting the first to third electrode terminals.

FIG. 9 is a circuit diagram of the protecting device according to the present technology.

FIG. 10 is a cross-sectional view of a protecting device according to the present technology, showing the state in which the fuse element is blown.

FIG. 11 is a cross-sectional view of a fuse element.

FIG. 12 is a circuit diagram showing an example configuration of a battery pack.

FIG. 13 shows the upper case and the lower case of a modification of a protecting device, in which FIG. 13A is a plan view of the upper case, FIG. 13B is a plan view of the lower case, FIG. 13C is a cross-sectional view taken along line H-H′ of the upper case shown in FIG. 13A, and FIG. 13D is a cross-sectional view taken along line I-I′ of the lower case shown in FIG. 13B.

FIG. 14 is a cross-sectional view of a protecting device in which a plurality of fixing members consisting of columnar members are formed on each inner front surface of the upper case and the lower case.

FIG. 15 is a cross-sectional view of a protecting device in which a plurality of fixing members consisting of columnar members are formed on each inner front surface of the upper case and the lower case.

FIG. 16 shows the upper case and the lower case of a modification of a protecting device, in which FIG. 16A is a plan view of the upper case, FIG. 16B is a plan view of the lower case, FIG. 16C is a cross-sectional view taken along line J-J′ of the upper case shown in FIG. 16A, and FIG. 16D is a cross-sectional view taken along line K-K′ of the lower case shown in FIG. 16B.

FIG. 17 shows the upper case and the lower case of the protecting device of a modification, in which FIG. 17A is a plan view of the upper case, FIG. 17B is a plan view of the lower case, FIG. 17C is a cross-sectional view taken along line L-L′ of the upper case shown in FIG. 17A, and FIG. 17D is a cross-sectional view taken along line M-M′ of the lower case shown in FIG. 17B.

FIG. 18 shows the upper case and the lower case of the protecting device of a modification, in which FIG. 18A is a plan view of the upper case, FIG. 18B is a plan view of the lower case, FIG. 18C is a cross-sectional view taken along line N-N′ of the upper case shown in FIG. 18A, and FIG. 18D is a cross-sectional view taken along line O-O′ of the lower case shown in FIG. 18B.

FIG. 19 shows the upper case and the lower case of the protecting device of a modification, in which FIG. 19A is a plan view of the upper case, FIG. 19B is a plan view of the lower case, FIG. 19C is a cross-sectional view taken along line P-P′ of the upper case shown in FIG. 19A, and FIG. 19D is a cross-sectional view taken along line Q-Q′ of the lower case shown in FIG. 19B.

FIG. 20 shows the upper case and the lower case of the protecting device of a modification, in which FIG. 20A is a plan view of the upper case, FIG. 20B is a plan view of the lower case, FIG. 20C is a cross-sectional view taken along line R-R′ of the upper case shown in FIG. 20A, and FIG. 20D is a cross-sectional view taken along line S-S′ of the lower case shown in FIG. 20B.

FIG. 21 is a cross-sectional view of a protecting device with a block-shaped member as a fixing member having a supporting surface facing the main surface portion of the insulating substrate.

FIG. 22 is a cross-sectional view of a protecting device with a block-shaped member as a fixing member having a supporting surface facing the main surface portion of the insulating substrate.

FIG. 23 shows the upper case and the lower case of a modification of the protecting device, in which FIG. 23A is a plan view of the upper case, FIG. 23B is a plan view of the lower case, FIG. 23C is a cross-sectional view taken along line T-T′ of the upper case shown in FIG. 23A, and FIG. 23D is a cross-sectional view taken along line U-U′ of the lower case shown in FIG. 23B.

FIG. 24 shows the upper case and the lower case of a protecting device of the modification, in which FIG. 24A is a plan view of the upper case, FIG. 24B is a plan view of the lower case, FIG. 24C is a cross-sectional view taken along line V-V′ of the upper case shown in FIG. 24A, and FIG. 24D is a cross-sectional view taken along line W-W′ of the lower case shown in FIG. 24B.

FIG. 25 is a cross-sectional view of a protecting device with a supporting piece as a fixing member provided on an inner surface of a case to support the outer edge of an insulating substrate.

FIG. 26 is a cross-sectional view of a protecting device with a supporting piece as a fixing member provided on an inner surface of a case to support the outer edge of an insulating substrate.

FIG. 27 is a plan view of a protecting device.

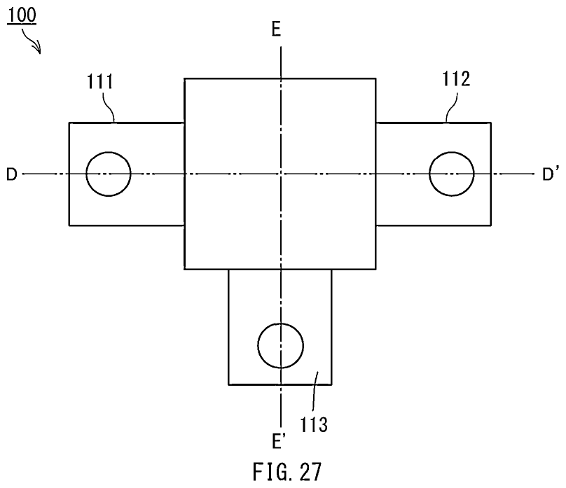

FIG. 28 is a cross-sectional view taken along line D-D′ of the protecting device shown in FIG. 27.

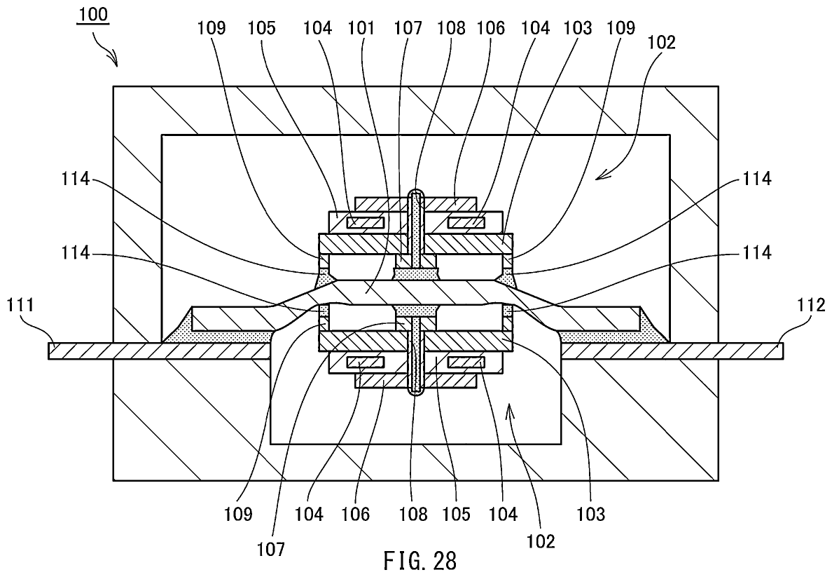

FIG. 29 is a cross-sectional view taken along line E-E′ of the protecting device shown in FIG. 27.

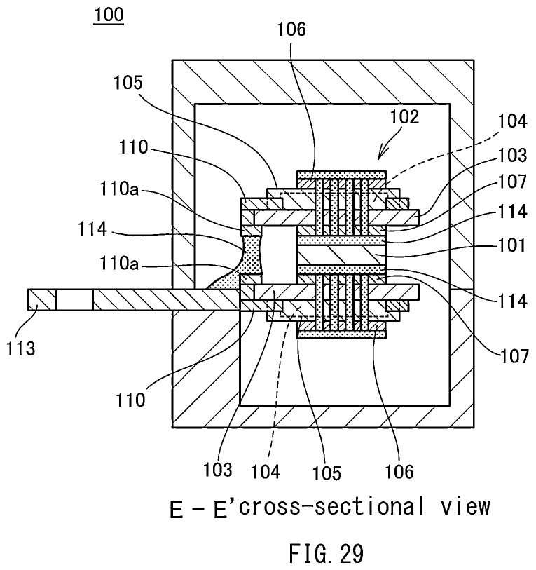

FIG. 30 shows the blowing member of the protecting device shown in FIG. 27, in which FIG. 30A is a plan view of the surface of the insulating substrate, and FIG. 30B is a bottom view of the back surface of the insulating substrate.

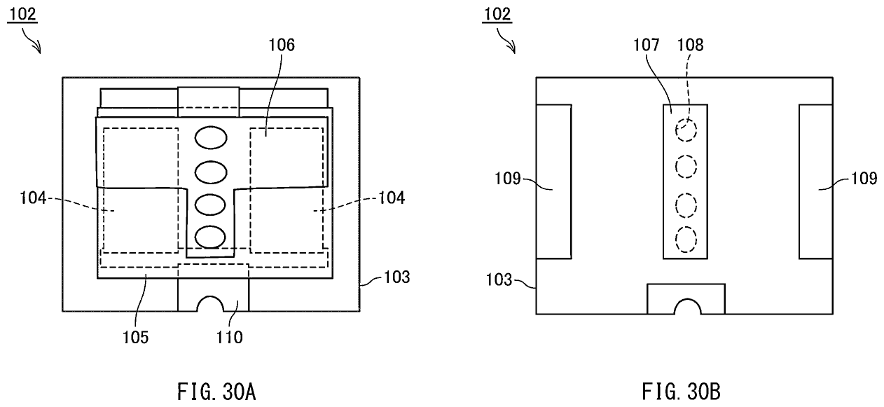

FIG. 31 is a cross-sectional view of the protecting device shown in FIG. 27, showing the state in which the blowing member wobbles, causing the insulating substrate to tilt, and the holding electrode that was in surface contact with the front and back surfaces of the fuse element detaches from the fuse element.

FIG. 32 is a cross-sectional view of the state in which the fuse element is partially uncut in the protecting device shown in FIG. 27.

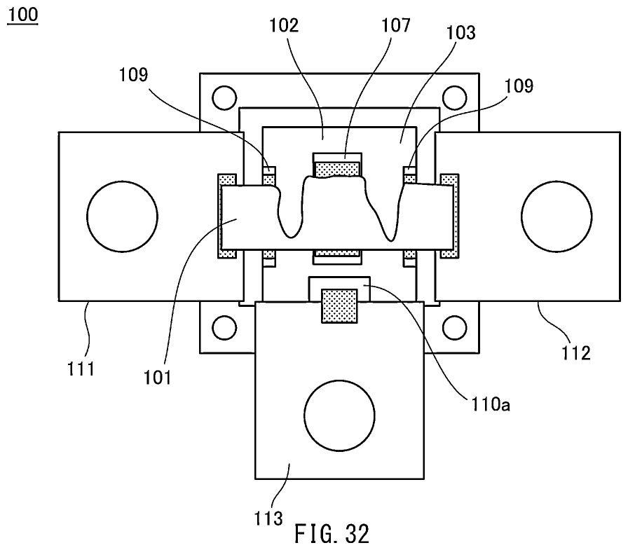

### DESCRIPTION OF EMBODIMENTS

Embodiments of a protecting device and a battery pack according to the present technology will now be more particularly described with reference to the accompanying drawings. It should be noted that the present technology is not limited to the embodiments described below and various modifications can be added to the embodiment without departing from the scope of the present technology. The features shown in the drawings are illustrated schematically and are not intended to be drawn to scale. Actual dimensions should be determined in consideration of the following description. Moreover, those skilled in the art will appreciate that dimensional relations and proportions may be different among the drawings in some parts.

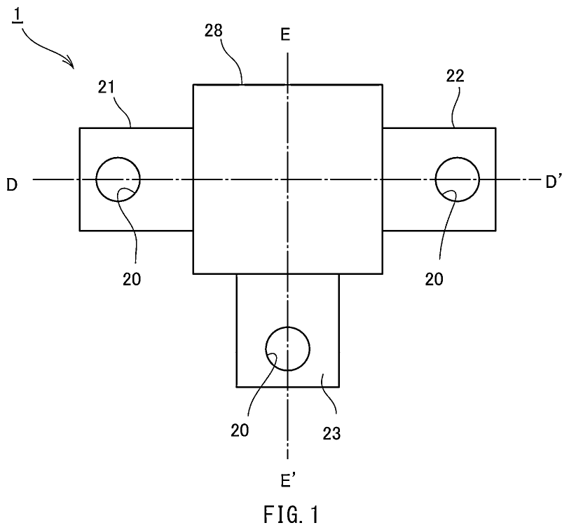

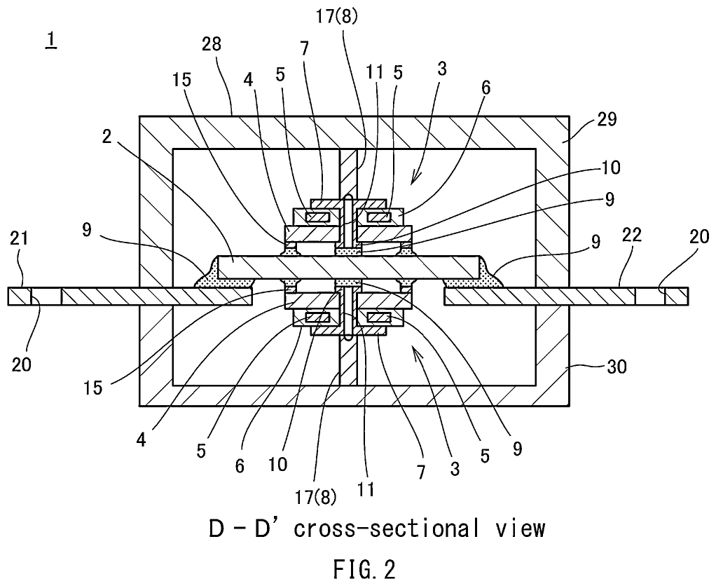

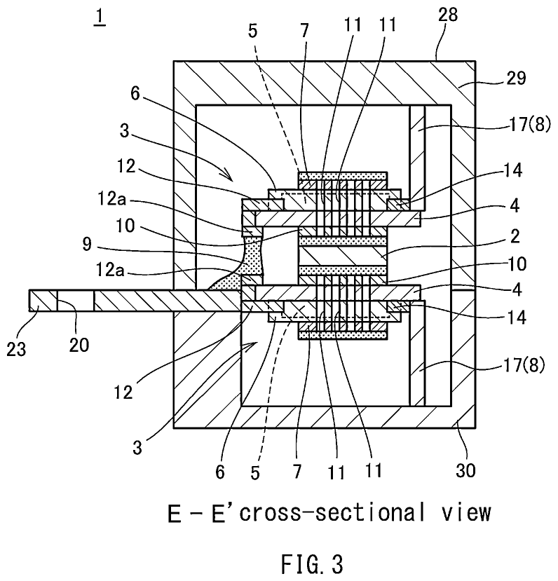

As shown in FIGS. 1 to 3, the protecting device 1 according to the present technology includes a case 28, a fuse element 2, a blowing member 3 connected to at least one side of the fuse element 2 to blow the fuse element 2, a fixing member 8 provided on the inner surface of the case 28 to contact the blowing member 3 to restrain the wobbling of the blowing member 3. FIG. 1 is a plan view of the protecting device 1, FIG. 2 is a cross-sectional view taken along line D-D′ of the protecting device 1 shown in FIG. 1, and FIG. 3 is a cross-sectional view taken along line E-E′ of the protecting device 1 shown in FIG. 1.

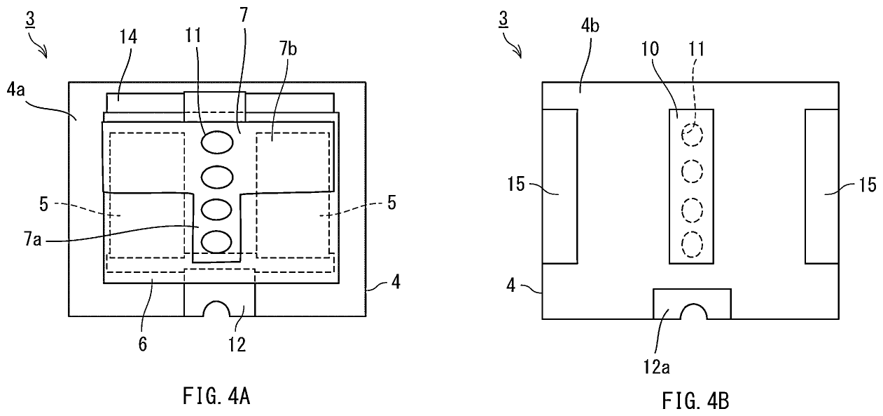

FIG. 4 shows the blowing member 3, in which FIG. 4A is a plan view of the front surface 4a of the insulating substrate 4, and FIG. 4B is a bottom view of the back surface 4b of the insulating substrate 4. The blowing member 3 includes an insulating substrate 4, a heat generator 5 formed on the front surface 4a side of the insulating substrate 4, an insulating layer 6 covering the heat generator 5, and a heat-generator lead-out electrode 7 connected to the heat generator 5 and superimposed with the heat generator 5 via the insulating layer 6.

On the back surface 4b that is the reverse side of the front surface 4a of the insulating substrate 4, a holding electrode 10 is formed to hold the melted conductor 2a of the fuse element 2 when the fuse element 2 melts, and the heat-generator lead-out electrode 7 and the holding electrode 10 are connected by a through-hole 11 penetrating the insulating substrate 4 to the heat-generator lead-out electrode 7.

The fuse element 2 is connected to the holding electrode 10 by a bonding material, such as connecting solder 9, which is conductive and softens when heated. The fuse element 2 is also connected to the first and second electrode terminals 21, 22, both ends of which are connected to an external circuit, by a bonding material such as the connecting solder 9.

According to this protecting device 1, a fixing member 8 is provided on the inner surface of the case 28, and this fixing member 8 is in contact with the blowing member 3 to suppress the wobbling of the blowing member 3. This prevents the insulating substrate 4 from tilting even when the fixing state of the blowing member 3 to the fuse element 2 becomes unstable due to the softening of the connecting solder 9 caused by the heat generated by the heat generator 5 during the blowing of the fuse element 2.

That is, according to the protecting device 1, the holding electrode 10, which is in surface contact with the fuse element 2, does not detach from the fuse element 2, and the heat of the heat generator 5 can be reliably transmitted to the fuse element 2. Therefore, when a large fuse element 2 corresponding to a large current is used, even if high heat is generated for a considerable time to blow this fuse element 2, the fixing state of the blowing member 3 can be stabilized and the current path can be interrupted safely and quickly.

The following is a detailed description of each configuration of the blowing member 3 of the protecting device 1 and the fuse element 2.

### Blowing Member Insulating Substrate

The blowing member 3 includes the insulating substrate 4. The insulating substrate 4 is formed of an insulating material such as alumina, glass ceramics, mullite, or zirconia. Alternatively, the insulating substrate 4 may be made of other materials used for printed wiring boards, such as glass epoxy and phenolic substrates. The heat generator 5 is formed on the front surface 4a of the insulating substrate 4.

In the present invention, the side on which the heat generator 5 is formed on the insulating substrate 4 is referred to as the front surface 4a, as shown in FIG. 4A, and the reverse side of the front surface 4a is referred to as the back surface 4b, as shown in FIG. 4B. The insulating substrate 4 has a through-hole 11 that connects the heat-generator lead-out electrode 7 formed on the front surface 4a and the holding electrode 10 formed on the back surface 4b, as described below.

### Heat Generator

The heat generator 5 is an electrically conductive member having a relatively high resistance value and generating heat when energized, and is made of, e.g., nichrome, W, Mo, Ru, or a material containing these materials. The heat generator 5 can be formed by mixing the powder of these alloys, the compositions, or compounds with a resin binder or the like to form a paste, forming a pattern on insulating substrate 4 using screen printing technology, and then baking the paste.

In the protecting device 1, two heat generators 5 are formed in parallel on the front surface 4a of the insulating substrate 4. Each heat generator 5 is connected to a heat-generator feeding electrode 12 at one end and to a heat-generator electrode 14 at the other end. The heat-generator feeding electrode 12 is connected to one end of the heat generator 5 and serves as a terminal for supplying power to the heat generator 5, and is continuous with the external connection electrode 12a formed on the back surface 4b of the insulating substrate 4 via castration. Each heat generator 5 is covered by the insulating layer 6, and the heat-generator lead-out electrode 7 formed on the insulating layer 6 is superimposed therewith.

The external connection electrode 12a is connected to the third electrode terminal 23, which is connected to the external circuit, by means of a bonding material, such as the connecting solder 9, which is conductive and softens when heated by the heat generated by the heat generator 5, thereby connecting to a power supply source provided in the external circuit and enabling power to the heat generator 5. The heat-generator electrode 14 is connected to the heat-generator lead-out electrode 7 described below.

The heat-generator feeding electrode 12 and the heat-generator electrode 14 are formed by conductive patterns such as Ag and Cu, respectively. On the surface of the heat-generator feeding electrode 12 and the heat-generator electrode 14, a film such as Ni/Au plating, Ni/Pd plating, Ni/Pd/Au plating, or the like is preferably coated by a known method such as plating. This allows the protecting device 1 to prevent oxidation of the heat-generator feeding electrode 12 and the heat-generator electrode 14, and to prevent fluctuations in ratings due to increased conduction resistance.

The heat-generator feeding electrode 12 is preferably provided with a regulatory wall (not shown) to prevent the connecting solder 9 connecting the external connection electrode 12a to the third electrode terminal 23 and melted during reflow mounting or the like from crawling up onto the heat-generator feeding electrode 12 via the castellation and wetly spreading over the heat-generator feeding electrode 12. The regulatory wall can be formed using an insulating material that does not have wettability to solder, such as glass, solder resist, or insulating adhesive, and can be formed by printing on the heat-generator feeding electrode 12. The regulatory wall prevents the melted solder 9 for connection from wetly spreading to the heat-generator feeding electrode 12, thereby maintaining the connectivity between the protecting device 1 and the external circuit board.

The insulating layer 6 is provided to protect and insulate the heat generator 5 and is made of, e.g., a glass layer. The insulating layer 6 is thinly formed, e.g., 10 to 40 μm in thickness. The insulating layer 6 may also be formed between the front surface 4a of the insulating substrate 4 and the heat generator 5.

### Heat-Generator Lead-Out Electrode

As with the heat-generator feeding electrode 12 and the heat-generator electrode 14, the heat-generator lead-out electrode 7 is formed by a conductive pattern of Ag, Cu, or the like. On the surface of the heat-generator lead-out electrode 7, a coating such as Ni/Au plating, Ni/Pd plating, Ni/Pd/Au plating, or the like is preferably coated by a known method such as plating.

The heat-generator lead-out electrode 7 is connected to the heat-generator electrode 14 at one end, is formed on the insulating layer 6, and is superimposed with the heat generator 5 via the insulating layer 6. The heat-generator lead-out electrode 7 includes a tip portion 7a extending between the two heat generators 5 in an area where the heat generators 5 are not formed, and a base portion 7b superimposed with the two heat generators 5 and connected to the heat-generator electrode 14. With respect to the width direction orthogonal to the current flow direction of the heat generators 5, the base portion 7b of the heat-generator lead-out electrode 7 is the wide portion formed superimposed with the two heat generators 5, and the tip portion 7a is the narrow portion protruding from the base portion 7b and extending into the area between the two heat generators 5.

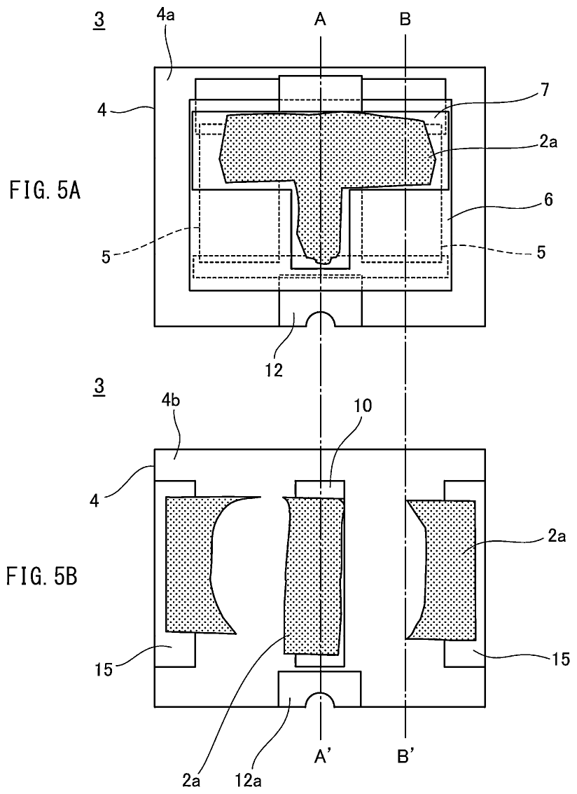

The heat-generator lead-out electrode 7 includes a through-hole 11 and is thus electrically and thermally connected to the holding electrode 10 formed on the back surface 4b of the insulating substrate 4. As a result, heat from the heat generator 5 is transferred to the fuse element 2 through the heat-generator lead-out electrode 7, the through-hole 11, and the holding electrode 10, causing the fuse element 2 to melt. The melted conductor 2a of the fuse element 2 is sucked into the through-hole 11 and held on the heat-generator lead-out electrode 7 (see FIG. 5).

### Holding Electrode

On the back surface 4b of the insulating substrate 4, a holding electrode 10 connected to the fuse element 2 by a connecting material such as the connecting solder 9, an auxiliary electrode 15, and an external connection electrode 12a are formed. The holding electrode 10 is formed at a position opposite to the heat-generator lead-out electrode 7 formed in the center of the front surface 4a via the insulating substrate 4. The holding electrode 10 is continuous with the heat-generator lead-out electrode 7 via a through-hole 11 that penetrates from the surface of the holding electrode 10 to the heat-generator lead-out electrode 7. As a result, the melted conductor 2a of the melted fuse element 2 is sucked to the heat-generator lead-out electrode 7 through the through-hole 11.

The auxiliary electrode 15, together with the holding electrode 10, is connected to the fuse element 2 and holds the melted conductor 2a. A pair of the auxiliary electrodes 15 are formed on both edges of the insulating substrate 4, thereby sandwiching the holding electrode 10.

The external connection electrode 12a, the holding electrode 10, and the auxiliary electrode 15 can be formed by screen printing or other known methods using known electrode materials such as Ag, Cu, or alloy materials mainly composed of Ag or Cu.

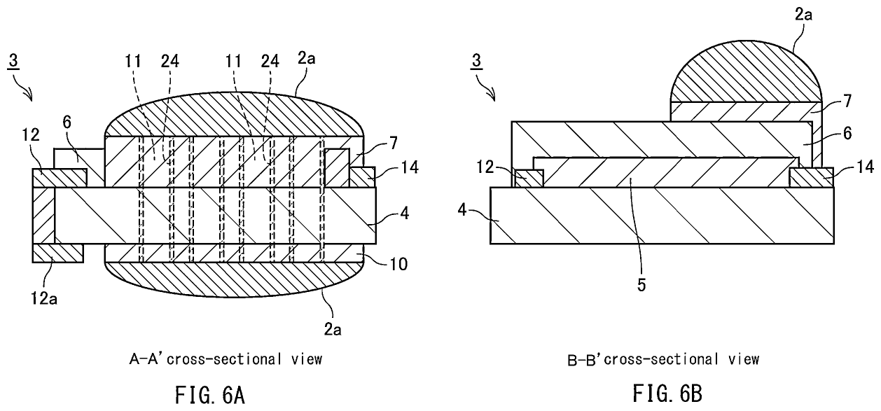

The through-hole 11 sucks the melted conductor 2a of the fuse element 2 by capillary phenomenon when the fuse element 2 melts, thereby reducing the volume of the melted conductor 2a held on the holding electrode 10. As a result, even when the fuse element 2a becomes larger due to the higher rating and higher capacity of the protecting device 1 and the amount of melting increases, a large volume of the melted conductor 2a can be held by the holding electrode 10, the heat-generator lead-out electrode 7, and the auxiliary electrode 15 as shown in FIG. 6 to securely blow the fuse element 2a.

The through-hole 11 is formed in the area of the insulating substrate 4 where the heat generator 5 is not formed. In the blowing member 3 shown in FIG. 4, the through-hole 11 is formed in the area between the parallel heat generators 5.

The through-hole 11 has a conductive layer 24 formed on the inner surface. The conductive layer 24 is continuous with the holding electrode 10 and the heat-generator lead-out electrode 7. As a result, the holding electrode 10 and the heat-generator lead-out electrode 7 are electrically connected through the conductive layer 24. In addition, the conductive layer 24 allows the heat of the heat generator 5 to be quickly transferred to the fuse element 2 via the heat-generator lead-out electrode 7 and the holding electrode 10.

Since the holding electrode 10 supports the fuse element 2 and the melted conductor 2a agglomerates during the blowing, the continuity between the holding electrode 10 and the conductive layer 24 makes it easier to guide the melted conductor 2a into the through-hole 11. In addition, the melted conductor 2a is wetly spread, and held by the heat-generator lead-out electrode 7, which is continuous with the conductive layer 24 (see FIGS. 5 and 6). Therefore, more amount of the melted conductor 2a can be sucked and held in the through-hole 11 and the heat-generator lead-out electrode 7, reducing the volume of the melted conductor 2a held by the holding electrode 10 and the auxiliary electrode 15, thereby ensuring the blowout.

The conductive layer 24 is formed, e.g., by copper, silver, gold, iron, nickel, palladium, lead, or tin, or an alloy mainly composed of any of these, and can be formed by electrolytic plating or printing conductive paste on the inner surface of the through-hole 11 or other known methods. The conductive layer 24 may also be formed by inserting a plurality of metal wires or an aggregate of conductive ribbons into the through-hole 11.

The blowing member 3 may be provided with a plurality of the through-holes 11. This increases the heat transfer path of the heat generator 5 to more quickly transfer heat to the fuse element 2, increases the path for sucking the melted conductor 2a of the fuse element 2, and reduces the volume of the melted conductor 2a at the melting portion by quickly sucking more amount of the melted conductor 2a.

### Case

The inside of the protecting device 1 is protected by the fuse element 2 and the blowing member 3 covered by the case 28. The case 28 can be formed from an insulating material such as various engineering plastics, thermoplastics, ceramics, and glass epoxy substrates, among others. The case 28 houses the fuse element 2 and the blowing member 3, and has sufficient internal space for the melted conductor 2a to expand spherically upon melting of the fuse element 2 and aggregate on the heat-generator lead-out electrode 7.

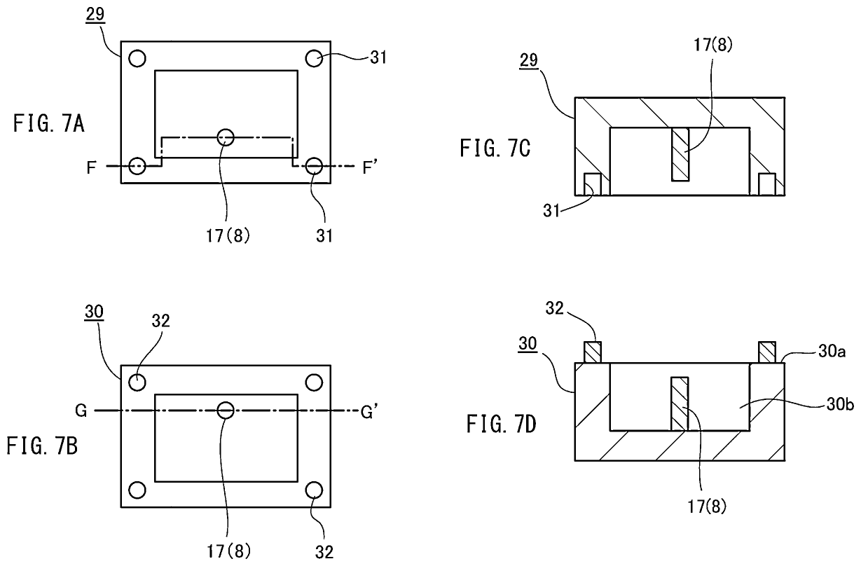

As shown in FIGS. 2, 3, and 7, the case 28 is formed by combining an upper case 29 and a lower case 30. FIG. 7 shows the upper case 29 and the lower case 30, in which FIG. 7A is a plan view of the upper case 29, FIG. 7B is a plan view of the lower case 30, FIG. 7C is a cross-sectional view taken along line F-F′ of the upper case 29 shown in FIG. 7A, and FIG. 7D is a cross-sectional view taken along line G-G′ of the lower case 30 shown in FIG. 7B. The upper case 29 is provided with a fitting recess 31 on the bottom surface of the side wall. The lower case 30 is provided with a fitting protrusion 32 that mates with the fitting recess 31 on the top surface of the side wall. The upper and lower cases 29, 30 are assembled by fitting the fitting protrusion 32 into the fitting recess 31 and are adhered together by adhesive material.

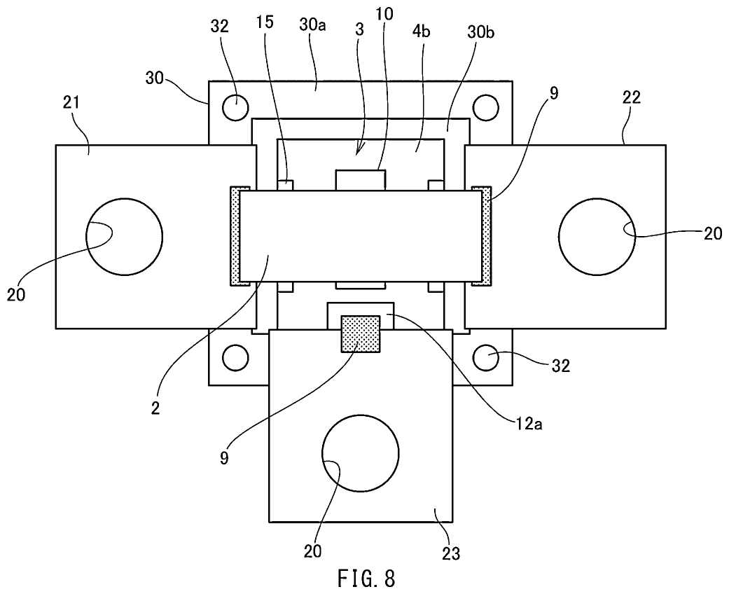

As shown in FIG. 8, the lower case 30 is formed in a substantially rectangular shape and includes a side edge portion 30a provided with the fitting protrusion 32 and supporting the first to third electrode terminals 21 to 23, and a hollow portion 30b where the blowing member 3 connected to the lower side of the fuse element 2 is located. The side edge portion 30a supports the first to third electrode terminals 21 to 23 arranged to extend from the inside to the outside of the case 28. The hollow portion 30b accommodates the blowing member 3 connected to the lower side of the fuse element 2 and has an internal space that allows the melted conductor 2a to wetly spread and aggregate on the heat-generator lead-out electrode 7.

The upper case 29 is formed in a substantially rectangular shape as with the lower case 30, and abut on and joined with the lower case 30 to cover the fuse element 2 and the blowing member 3 connected to the upper side of the fuse element 2. The upper case 29 has an internal space that allows the melted conductor 2a to wetly spread and aggregate on the heat-generator lead-out electrode 7.

### Fixing Member

The inner surface of the case 28 is provided with the fixing member 8 that restrains the wobbling of the blowing member 3 by contacting the blowing member 3. The fixing member 8 is supported on the inner surface of the case 28 and protrudes to the vicinity of the blowing member 3. The fixing member 8 contacts the blowing member 3 when the heat generated by the heat generator 5 softens the connecting solder 9 and makes the fixing state of the blowing member 3 to the fuse element 2 unstable during the melting of the fuse element 2. As a result, the wobbling of the blowing member 3 is suppressed, and the holding electrode 10, which is in surface contact with the fuse element 2, does not detach from the fuse element 2, and the heat generated by the heat generator 5 is reliably transferred to the fuse element 2.

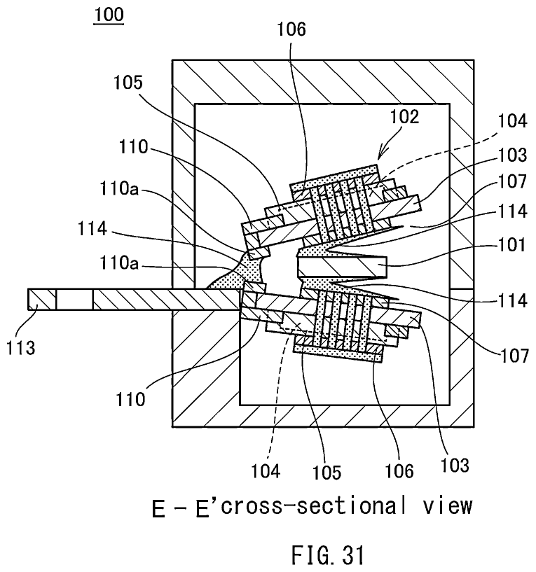

As shown in FIG. 3, in the blowing member 3, the external connection electrode 12a provided on one side edge of the insulating substrate 4 is connected to the third electrode terminal 23 by the connecting solder 9 or other connecting material. The connecting solder 9, which connects the fuse element 2 and the holding electrode 10 in surface contact, softens when the holding electrode 10 is heated in the blowing process of the fuse element 2. This may cause the insulating substrate 4 to tilt toward the external connection electrode 12a, separating the holding electrode 10 from the fuse element 2, resulting in insufficient heating to the fuse element 2 (see FIG. 31).

The protecting device 1 is provided with the fixing member 8 supported on the inner surface of the case 28, and this fixing member 8 contacts the blowing member 3 to suppress the wobbling of the blowing member 3. Therefore, even when the large fuse element 2 corresponding to a large current is used and high heat is generated for a considerable time to blow this fuse element 2, the fixing state of the blowing member 3 to the fuse element 2 is stabilized and the fuse element 2 is heated sufficiently through the holding electrode 10, thereby blowing the fuse element 2 to interrupt the current path safely and quickly.

The fixing member 8 can be made of various engineering plastics and thermoplastics, among others. The fixing member 8 can be a separate member that is separate from the case 28 and can be provided by adhering it to the inner surface of the case 28. Alternatively, the fixing member 8 can be provided by integral molding with the case 28.

The fixing member 8 can be formed by a columnar member 17, as shown, e.g., in FIGS. 2, 3, and 7. The columnar member 17 protrudes from the top surface of the upper case 29 and the bottom surface of the lower case 30 and is in contact with the blowing member 3 connected to one side and the other side of the fuse element 2, respectively. The columnar member 17 may have its tip in contact with the blowing member 3 in advance, or the tip may be provided in close proximity to the blowing member 3 and come into contact with the blowing member 3 when the blowing member 3 wobbles. The number of the columnar members 17 in contact with each blowing member 3 may be one or more. The size of the contacting surface of the columnar member 17 with the blowing member 3 is set according to the contacting position of the blowing member 3.

The location for the fixing member 8 of the blowing member 3 to contact is preferably a corner of the front surface 4a of the insulating substrate 4, on the insulating layer 6, or any other location that does not inhibit the aggregation of the melted conductor 2a. In particular, as shown in FIGS. 3 and 7, the fixing member 8 is preferably provided to contact the side edge of the insulating substrate 4 opposite the side edge where the external connection electrode 12a is formed and facing the external connection electrode 12a. This effectively prevents the insulating substrate 4 from tilting toward the external connection electrode 12a.

The fixing member 8 may be provided with an interface material (not shown) to cushion and prevent sticking with the blowing member 3 at the location where it contacts the blowing member 3. Examples of the interface material may include, but are not limited to, rubber material, elastic resin, nonwoven fabric, and nonwoven fabric or inorganic fiber material impregnated with elastic resin. The interface material can be provided at the tip portion of the fixing member 8 by means of an adhesive material. The interface material can also be provided by covering the tip of the fixing member 8 with an adhesive material if the material itself has adhesive properties. The interface material can prevent damage such as damage or sticking due to contact between the fixing member 8 and the blowing member 3 and can maintain the performance of the fixing member 8 and the blowing member 3.

### Formation Steps of Blowing Member

The blowing member 3 is prepared by forming the heat-generator feeding electrode 12 and the heat-generator electrode 14 on the front surface 4a of the insulating substrate 4 by screen printing or other known methods, forming the heat generator 5, and then laminating the insulating layer 6. Next, the heat-generator lead-out electrode 7 is formed. The back surface 4b of the insulating substrate 4 is also formed using screen printing or other known methods to form the holding electrode 10, the external connection electrode 12a, and the auxiliary electrode 15. Thereafter, the through-holes 11 are formed by drilling or the like, and the conductive layer 24 is formed by plating or the like to complete the blowing member 3. In the blowing member 3, the holding electrode 10 and the auxiliary electrode 15 are connected to the fuse element 2 by the connecting solder 9. The fuse element 2 to which the blowing member 3 is connected is connected, by the connecting solder 9, to the first and second electrode terminals 21, 22 supported on a side edge portion 30a of a lower case 30. The external connection electrode 12a of the insulating substrate 4 is connected, by the connecting solder 9, to the third electrode terminal 23 supported on the side edge portion 30a of the lower case 30.

### Fuse Element Sandwiching Configuration

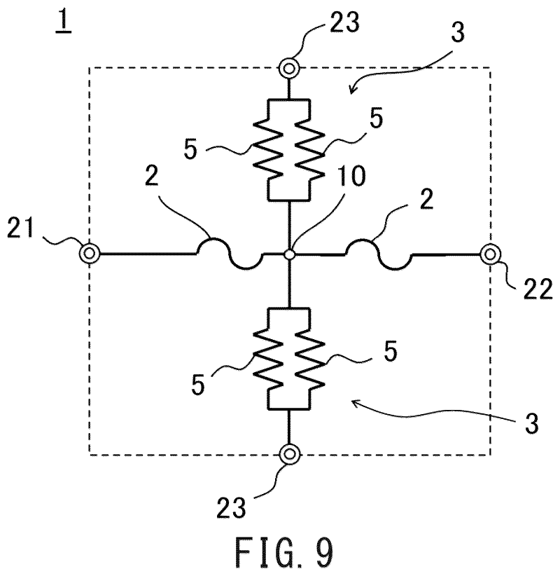

In the protecting device 1 shown in FIG. 2, the blowing members 3 are connected to one side of the fuse element 2 and to the other side opposite to the one side, respectively, whereby the fuse element 2 is sandwiched between multiple blowing members 3. FIG. 9 is a circuit diagram of the protecting device 1. In each of the blowing members 3 connected to one side and the other side of the fuse element 2, one end of the heat generator 5 is respectively connected to the fuse element 2 via the heat-generator lead-out electrode 7 and the holding electrode 10 formed on each of the insulating substrates 4. In addition, in each of the blowing members 3, the heat-generator feeding electrode 12 connected to the other end of the heat generator 5 is respectively connected to the third electrode terminal 23 via a connecting material such as the connecting solder 9, thereby being connected to a power source for heating the heat generator 5 provided in an external circuit via the third electrode terminal 23.

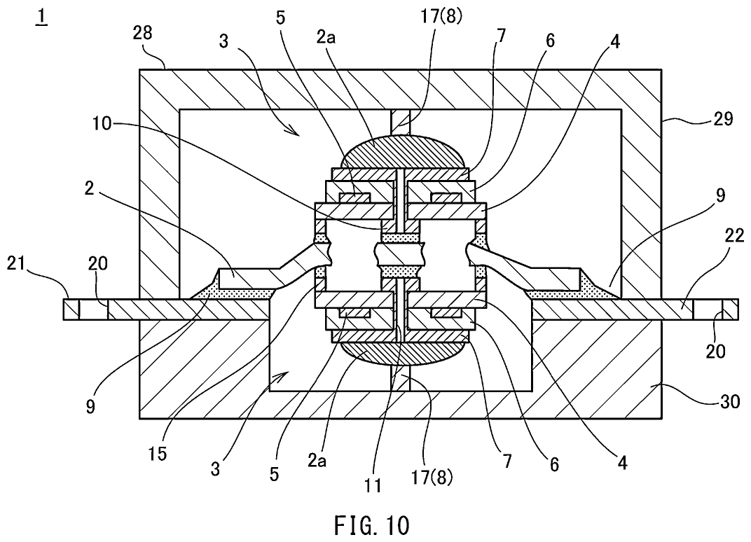

As shown in FIG. 10, in the protecting device 1, when the fuse element 2 is blown by the heat of the heat generator 5, the heat generators 5 of each blowing member 3, 3 connected to both sides of the fuse element 2 generate heat and apply the heat to the fuse element 2 from both sides. Therefore, the protecting device 1 can quickly heat and blow the fuse element 2 even when the cross-sectional area of the fuse element 2 is increased to accommodate high current applications.

In addition, the protecting device 1 sucks the melted conductor 2a from both sides of the fuse element 2 into the respective through-holes 11 formed in each of the blowing members 3 and holds the melted conductor 2a with the heat-generator lead-out electrode 7. Therefore, even when a large amount of the melted conductor 2a is generated because the cross-sectional area of the fuse element 2 is increased to accommodate high current applications, the protecting device 1 is capable of reliably blowing the fuse element 2 by sucking the melted conductor 2a with the plurality of blowing members 3. In addition, the protecting device 1 can blow the fuse element 2 more quickly by sucking the melted conductor 2a with the plurality of blowing members 3.

The protecting device 1 can also quickly blow the fuse element 2 when the fuse element 2 employs a coated structure in which a low-melting-point metal constituting the inner layer is coated with a high-melting-point metal. Specifically, the fuse element 2 coated with high-melting-point metal takes time to heat up to the temperature at which the high-melting-point metal of the outer layer melts, even when the heat generator 5 generates heat. Here, by providing the plurality of blowing members 3 in the protecting device 1 and heating each heat generator 5 simultaneously, the high-melting-point metal of the outer layer can be quickly heated to the melting temperature. Therefore, according to the protecting device 1, the thickness of the high-melting-point metal layer that constitutes the outer layer can be made thicker, and the rapid blowout property can be maintained while achieving a higher rating.

In addition, in the protecting device 1, it is preferable that a pair of blowing members 3, 3 connected to the fuse element 2 face each other, as shown in FIG. 2. This allows the protecting device 1 to simultaneously heat the same part of the fuse element 2 from both sides and suck the melted conductor 2a by the pair of blowing members 3,3, thereby heating to blow the fuse element 2 more quickly.

In addition, it is preferable for the protecting device 1 that the holding electrode 10 and the auxiliary electrode 15 formed on the respective insulating substrates 4 of the pair of blowing members 3, 3 face each other through the fuse element 2. This symmetrical connection of the pair of blowing members 3, 3 suppresses unbalance in the load applied by the blowing member 3 to the fuse element 2 during reflow mounting and heating of the fuse element 2 and improves the resistance to the deformation of the fuse element 2 and misalignment of the blowing member 3.

It is preferable to form the heat generator 5 on both sides of the through-hole 11 to heat the holding electrode 10 and the heat-generator lead-out electrode 7 and to aggregate and suck more of the melted conductor 2a.

### Fuse Element 2

The fuse element 2 is mounted between the first and second electrode terminals 21, 22 and melts due to heat generation caused by the heat generator 5 being energized or self-heating (Joule heat) caused by a current exceeding its rated value flowing therethrough, thereby interrupting the current path between the first and second electrode terminals 21, 22.

The fuse element 2 can be any conductive material that melts due to heat generated by energizing the heat generator 5 or by an overcurrent condition, and for example, may be made of SnAgCu-based Pb-free solder as well as BiPbSn alloy, BiPb alloy, BiSn alloy, SnPb alloy, PbIn alloy, ZnAl alloy, InSn alloy, and PbAgSn alloys, among other materials.

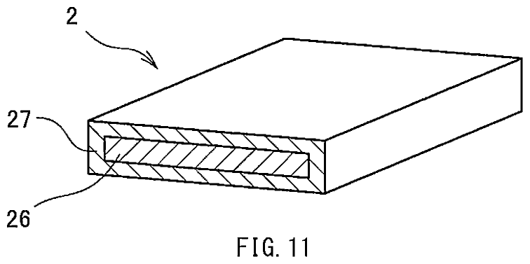

The fuse element 2 may have a structure having a high-melting-point metal and a low-melting-point metal. For example, as shown in FIG. 11, the fuse element 2 may have a laminated structure consisting of an inner layer and an outer layer and may include a low-melting-point metal layer 26 as the inner layer and a high-melting-point metal layer 27 as the outer layer laminated on the low-melting-point metal layer 26. The fuse element 2 is connected to the first and second electrode terminals 21, 22, the holding electrode 10, and the auxiliary electrode 15 via a bonding material such as the connecting solder 9.

The low-melting-point metal layer 26 is preferably a solder or Sn-based metal and is commonly referred to as “Pb-free solder”. The melting point of the low-melting-point metal layer 26 does not necessarily need to be higher than the temperature of the reflow oven and may melt at about 200° C. The high-melting-point metal layer 27 is a metal layer laminated on the surface of the low-melting-point metal layer 26, made of, e.g., Ag or Cu, or a metal mainly composed of one of these, and has a high melting point that does not melt even when the first and second electrode terminals 21, 22, the holding electrode 10, and the auxiliary electrode 15 are connected to the fuse element 2 by reflow.

The fuse element 2 can be formed by depositing a high-melting-point metal layer on a low-melting-point metal foil using plating technology, or by using other known lamination and film-formation technologies. The fuse element 2 may have a structure in which the entire surface of the low-melting-point metal layer 26 is covered by the high-melting-point metal layer 27 or may have a structure in which it is covered except for a pair of opposing sides. The fuse element 2 can be formed in various configurations, such as having the high-melting-point metal layer 27 as the inner layer and the low-melting-point metal layer 26 as the outer layer, having a multilayer structure with three or more alternating layers of low-melting-point metal and high-melting-point metal layers, or having an opening in part of the outer layer to expose a part of the inner layer.

By laminating the high-melting-point metal layer 27 as the outer layer on the low-melting-point metal layer 26 as the inner layer, the fuse element 2 can maintain the shape as a fuse element 2 even when the reflow temperature exceeds the melting temperature of the low-melting-point metal layer 26 and will not be blown. Therefore, the first and second electrode terminals 21, 22, the holding electrode 10, and the auxiliary electrode 15 can be efficiently connected to the fuse element 2 by reflow, and it is possible to prevent changes in blowout properties, which might otherwise cause a problem in which the fuse element 2 might be deformed to locally increase or decrease the resistance value so that it cannot be blown at a predetermined temperature or will be blown below a predetermined temperature. Therefore, the protecting device 1 can quickly blow the fuse element 2 by a predetermined overcurrent or heat generation of the heat generator 5.

In addition, the fuse element 2 does not melt due to self-heating as long as the predetermined rated current flows. When a current exceeding the rated value flows, the fuse element 2 melts due to self-heating (Joule heat) and interrupts the current path between the first and second electrode terminals 21, 22.

Furthermore, when the heat generator 5 is energized and generates heat, the fuse element 2 is blown to interrupt the current path between the first and second electrode terminals 21, 22. At this time, in the fuse element 2, the melted low-melting-point metal layer 26 erodes the high-melting-point metal layer 27 (solder erosion), whereby the high-melting-point metal layer 27 melts at a temperature lower than the melting temperature thereof. Thus, the fuse element 2 can be blown in a short time by utilizing the erosion action on the high-melting-point metal layer 27 by the low-melting-point metal layer 26. In addition, since the fuse element 2 is separated by the physical drawing action of the melted conductor 2a by the holding electrode 10 and the auxiliary electrode 15, the fuse element 2 can quickly and reliably interrupt the current path between the first and second electrode terminals 21, 22 (FIGS. 5 and 9).

The fuse element 2 may be made so that the volume of the low-melting-point metal layer 26 is larger than the volume of the high-melting-point metal layer 27. The fuse element 2 is heated by self-heating due to overcurrent or by heat generated by the heat generator 5, and the low-melting-point metal melts and erodes the high-melting-point metal, which can quickly melt and blow the fuse element 2. Therefore, by forming the volume of the low-melting-point metal layer 26 larger than that of the high-melting-point metal layer 27, the fuse element 2 can promote this erosion action and quickly interrupt the path between the first and second electrode terminals 21, 22.

Further, the fuse element 2, which is composed of the high-melting-point metal layer 27 laminated on the low-melting-point metal layer 26 serving as the inner layer can significantly reduce the melting temperature compared to conventional chip fuses and other fuses made of high-melting-point metals. Therefore, the fuse element 2 can be formed to have a larger cross-sectional area and a much higher current rating compared to chip fuses of the same size. In addition, the fuse element 2 can be made smaller and thinner than conventional chip fuses having the same current rating and is excellent in the rapid blowout property.

In addition, the fuse element 2 can improve resistance to a surge (pulse resistance) which would occur when an abnormally high voltage is momentarily applied to the electric system incorporating the protecting device 1. For example, the fuse element 2 must not be blown in the case of a 100 A current flowing for a few milliseconds. In this respect, since a large current flowing for an extremely short time flows through the surface layer of the conductor (skin effect), and the fuse element 2 is provided with a high-melting-point metal layer 27 such as Ag plating with low resistance as an outer layer, a current caused by a surge can easily flow to prevent blowout due to self-heating. Therefore, the fuse element 2 can significantly improve serge tolerance compared to fuses made of conventional solder alloys.

The fuse element 2 may be coated with flux (not shown) to prevent oxidation and to improve wettability at the time of blowout.

The first and second electrode terminals 21, 22, which are connected to the ends of the fuse element 2, are conductive terminals and are arranged to extend from the inside to the outside of the case 28 of the protecting device 1. The first and second electrode terminals 21, 22 provided with screw holes 20 in the tip portions that are led out of the case 28 and can be connected to connection electrodes provided in an external circuit by screwing or other means.

The third electrode terminal 23, which is connected to the external connection electrode 12a connected to the heat-generator feeding electrode 12 described above, is similarly arranged to extend from the inside to the outside of the case 28 of the protecting device 1 and is provided with screw holes 20 at the tip that is led out of the case 28.

### Circuit Configuration Example

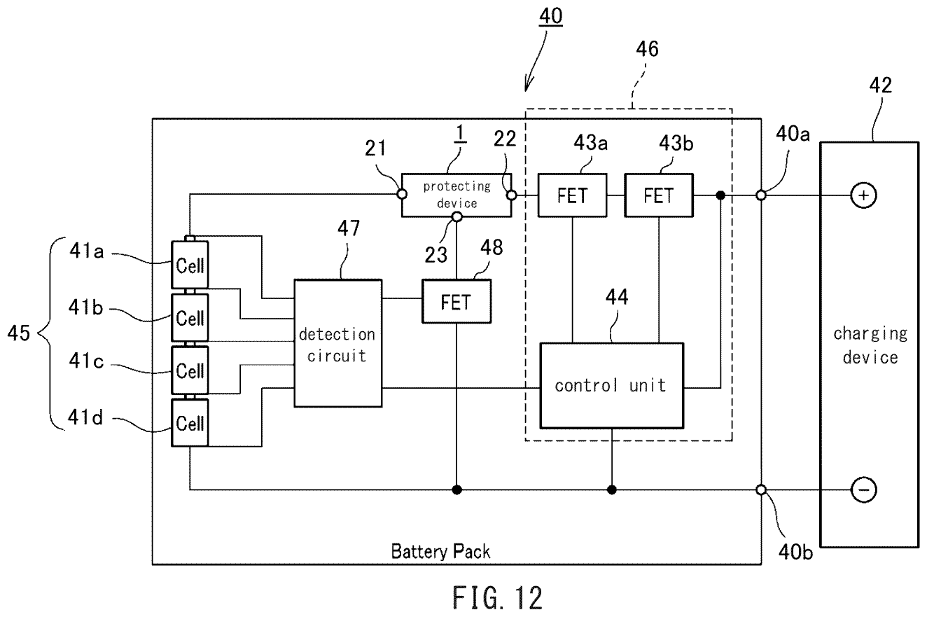

As shown in FIG. 12, this protecting device 1 is used, e.g., in a circuit in a battery pack 40 of a lithium-ion rechargeable battery. The battery pack 40 includes a battery stack 45 including, e.g., a total of four battery cells 41a to 41d of lithium ion secondary batteries.

The battery pack 40 includes: the battery stack 45, a charge/discharge control circuit 46 for controlling the charge/discharge of the battery stack 45; the protecting device 1 according to the present invention for interrupting a charging/discharging path when the state of the battery stack 45 is abnormal; a detection circuit 47 for detecting the voltage of each battery cell 41a to 41d; and a current control element 48 serving as a switching element to control the operation of the protecting device 1 according to the detection results of the detection circuit 47.

In the battery stack 45, battery cells 41a to 41d requiring control for protection against over-charging and over-discharging states are connected in series and are detachably connected to the charging device 42 via a positive electrode terminal 40a and a negative electrode terminal 40b of the battery pack 40, so as to apply charging voltage from the charging device 42. By connecting the positive electrode terminal 40a and the negative electrode terminal 40b to a battery-driven electronic device, the battery pack 40 charged by the charging device 42 can drive this electronic device.

The charge/discharge control circuit 46 includes two current control elements 43A, 43B connected in series in the current path between the battery stack 45 and the charging device 42, and a control unit 44 that controls the operation of these current control elements 43A, 43B. The current control elements 43a, 43b are formed of, e.g., field effect transistors (hereinafter referred to as FETs), and the control unit 44 controls the gate voltage to switch the current path of the battery stack 45 between a conduction state and interrupted state in the charging and/or discharging direction. The control unit 44 is powered by the charging device 42 and controls the operation of the current control elements 43a, 43b according to the detection results by the detection circuit 47 to interrupt the current path when the battery stack 45 is over-discharged or over-charged.

The protecting device 1 is connected, e.g., in the charge/discharge current path between the battery stack 45 and the charge/discharge control circuit 46, and the operation thereof is controlled by the current control element 48.

The detection circuit 47 is connected to each of the battery cells 41a to 41d so as to detect the voltage values of each of the battery cells 41a to 41d and supplies each of the voltage values to the control unit 44 of the charge/discharge control circuit 46. Furthermore, the detection circuit 47 outputs a control signal to control the current control element 48 when an over-charging voltage or over-discharging voltage is detected in any one of the battery cells 41a to 41d.

When the detection signal output from the detection circuit 47 indicates a voltage exceeding a predetermined threshold value corresponding to the over-discharging or over-charging state of the battery cells 41a to 41d, the current control element 48 such as an FET, for example, activates the protecting device 1 to interrupt the charging/discharging current path of the battery stack 45 without the switching operation of the current control elements 43a, 43b.

The protecting device 1 according to the present invention, which is used in the battery pack 40 having the configuration, has the circuit configuration shown in FIG. 9. That is, in the protecting device 1, the first electrode terminal 21 is connected to the battery stack 45 side, and the second electrode terminal 22 is connected to the positive electrode terminal 40a side, whereby the fuse element 2 is connected in series on the charging/discharging path of the battery stack 45. Furthermore, in the protecting device 1, the heat generator 5 is connected to the current control element 48 via the heat-generator feeding electrode 12 and the third electrode terminal 23, and the heat generator 5 is connected to the open end of the battery stack 45. As a result, one end of the heat generator 5 is connected to the fuse element 2 and one open end of the battery stack 45 via the heat-generator lead-out electrode 7 and the holding electrode 10, and the other end is connected to the other open end of the current control element 48 and the battery stack 45 via the third electrode terminal 23. This forms a power supply path to the heat generator 5 the conduction of which is controlled by the current control element 48.

### Operation of Protecting Device

When the protecting device 1 is mounted on an external circuit board, the heat generator 5 is connected to the current control element 48 and other elements formed in the external circuit via the third electrode terminal 23, and energization and heat generation of the heat generator 5 are regulated under normal conditions. Upon detecting an abnormal voltage in any of the battery cells 41a to 41d, the detection circuit 47 outputs an interruption signal to the current control element 48. The current control element 48 then controls the current to energize the heat generator 5. The heat generator 5 begins to generate heat when current flows from the battery stack 45.

The heat of the heat generator 5 is transferred to the fuse element 2 through the heat-generator lead-out electrode 7, the through-hole 11, and the holding electrode 10, and from the insulating substrate 4 through the holding electrode 10 and auxiliary electrode 15, causing fuse element 2 to melt. The melted conductor 2a aggregates on the holding electrode 10, the auxiliary electrode 15, and the heat-generator lead-out electrode 7, and the fuse element 2 is thus blown between the holding electrode 10 and the auxiliary electrode 15 (FIGS. 5, 6, and 10).

Furthermore, in the protecting device 1, by forming the fuse element 2 with a high-melting-point metal and a low-melting-point metal, the low-melting-point metal melts before the high-melting-point metal melts, and the fuse element 2 can be blown in a short time by utilizing the erosive action on the high-melting-point metal by the melted low-melting-point metal.

When the fuse element 2 is blown, the charging/discharging path of the battery stack 45 is interrupted between the first and second electrode terminals 21, 22. The heat generator 5 also stops generating heat because the blowout of the fuse element 2 also interrupts the power supply path to itself.

Here, the protecting device 1 is provided with the fixing member 8 on the inner surface of the case 28, which contacts the blowing member 3 to prevent the blowing member 3 from wobbling. As a result, even when the fixing state of the blowing member 3 to the fuse element 2 becomes unstable due to the softening of the connecting solder 9 caused by the heat generated by the heat generator 5, the tilting of the insulating substrate 4 can be suppressed and the holding electrode 10 does not detach from the fuse element 2, so that the fuse element 2 can be blown safely and quickly.

In addition, when a rate-exceeding overcurrent flows through the fuse element 2, the protecting device 1 can blow the fuse element 2 by self-heating to interrupt the charging/discharging path of the battery pack 40.

The protecting device 1 of the present invention is not limited to use in battery packs for lithium-ion secondary batteries, but can of course be applied to a variety of applications requiring the interruption of current paths by electrical signals.

### Modification 1

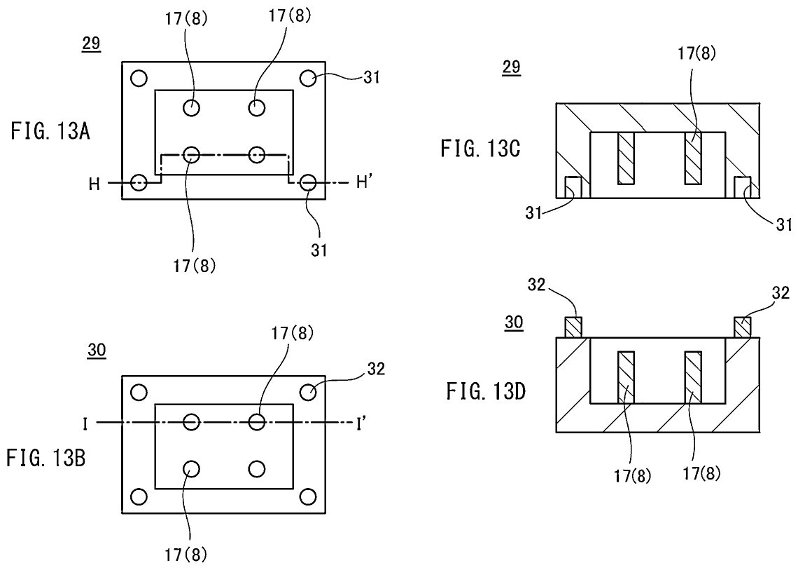

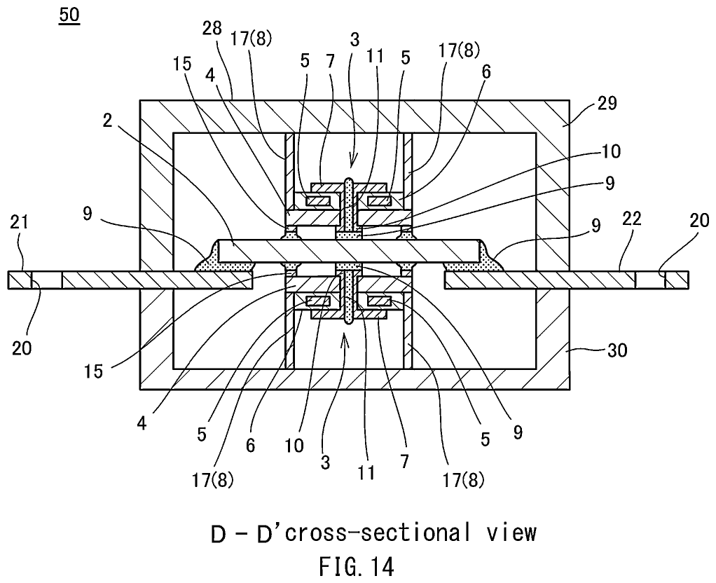

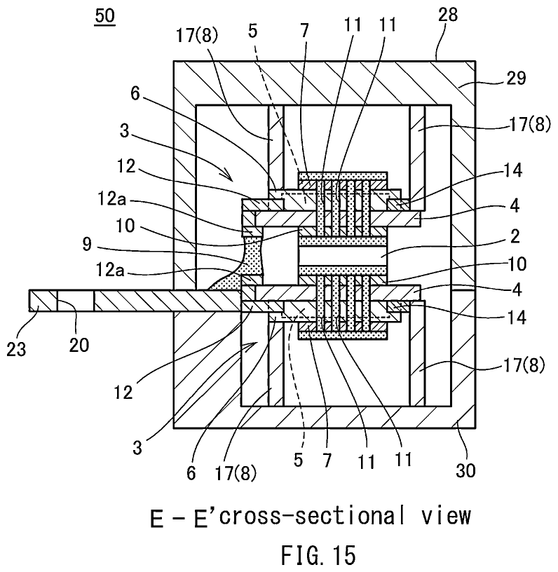

Next, a modification of the fixing member 8 is described. In the following description, the same symbols may be used for the same components as in the above-described protecting device 1, and the details may be omitted. As shown in FIGS. 13 to 15, the protecting device 50 has a plurality of columnar members 17 formed on each inner front surface of the upper case 29 and lower case 30. The protecting device 50 has four columnar members 17 on the top surface of the upper case 29, which are erected to contact the four corners of the rectangularly-shaped insulating substrate 4. Similarly, the protecting device 50 also has four columnar members 17 on the bottom surface of the lower case 30, which are erected to contact the four corners of the rectangularly-shaped insulating substrate 4.

FIG. 13 shows the upper case 29 and lower case 30 of the protecting device 50, in which FIG. 13A is a plan view of the upper case 29, FIG. 13B is a plan view of the lower case 30, FIG. 13C is a cross-sectional view taken along line H-H′ of the upper case 29 shown in FIG. 13A, and FIG. 13D is a cross-sectional view taken along line I-I′ of the lower case 30 shown in FIG. 13B.

According to the protecting device 50, since the four corners of the insulating substrate 4 are supported by the columnar member 17, the wobbling of the blowing member 3 can be suppressed for all angles. From the viewpoint of symmetrical mounting positions of the blowing member 3 connected to both sides of the fuse element 2, each of the columnar members 17 of the upper case 29 and lower case 30 are preferably formed at positions facing each other. In addition, each of the columnar members 17 may be provided with the interface material described above on the contact surface with the blowing member 3.

### Modification 2

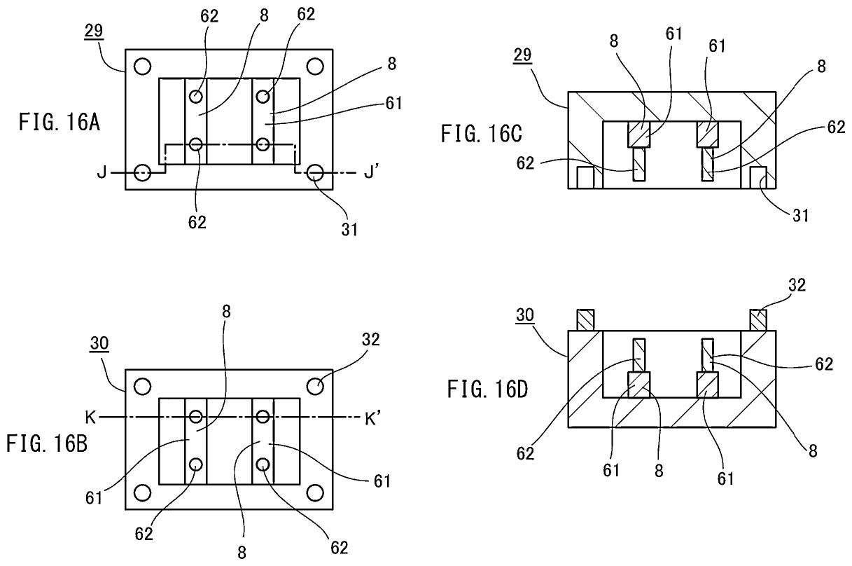

Next, another modification of the fixing member 8 will be described. In the following description as well, the same parts and materials as those of the above-described protecting device 1 are indicated with the same symbols and their details may be omitted. The protecting device 60 shown in FIG. 16 is provided with the fixing member 8 having a base portion 61 formed on the inner front surface of the case 28 and a plurality of protruding portions 62 protruding from the base portion 61 toward the insulating substrate 4 of the blowing member 3 and contacting the blowing member 3.

FIG. 16 shows the upper case 29 and lower case 30 of the protecting device 60, in which FIG. 16A is a plan view of the upper case 29, FIG. 16B is a plan view of the lower case 30, FIG. 16C is a cross-sectional view taken along line J-J′ of the upper case 29 shown in FIG. 16A, and FIG. 16D is a cross-sectional view taken along line K-K′ of the lower case 30 shown in FIG. 16B.

The base portions 61 have a substantially rectangular parallelepiped shape and are provided on the top surface of the upper case 29 and the bottom surface of the lower case 30. In the protecting device 60 shown in FIG. 16, the base portions 61 are provided to extend across opposite sides of the upper case 29 and across opposite sides of the lower case 30. This allows for precise positioning of the protruding portions 62 on the base portions 61.

A plurality of protruding portions 62 made of a columnar member protrude from each of the base portions 61. Each of the protruding portions 62 may be formed integrally with the base portion 61 or may be connected to the base portion 61 by adhesion or other means.

The protruding portions 62 are erected to contact a predetermined position of the blowing member 3. In the protecting device 60 shown in FIG. 16, four protruding portions 62 are erected in each of the upper and lower cases 29, 30 so as to contact the four corners of the insulating substrate 4, which is formed in a rectangular shape. The protruding portions 62 may have their tips in contact with the blowing member 3, or they may be provided with their tips in close proximity to the blowing member 3 so as to come into contact when the blowing member 3 wobbles. The size of the contact surface of the protruding portion 62 with the blowing member 3 is set according to the contact position of the blowing member 3. The protruding portion 62 may be provided with the interface material described above on the contact surface with the blowing member 3.

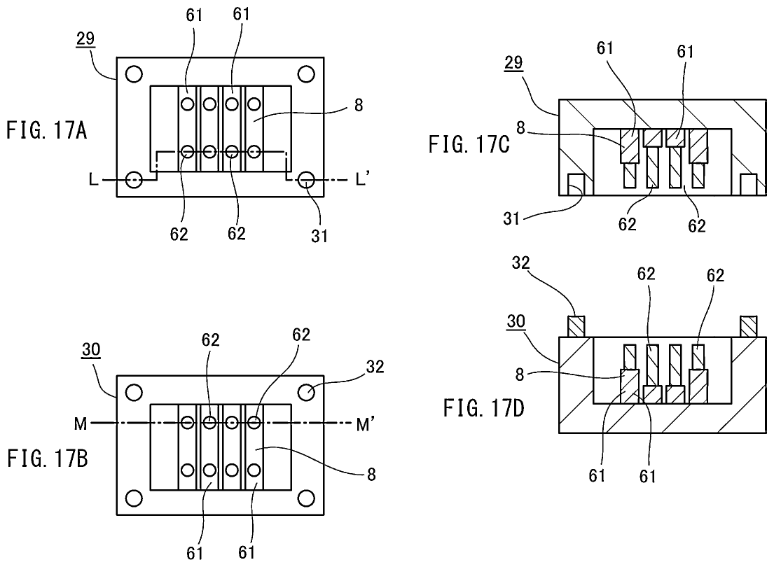

The protecting device 60 may have the protruding portions 62 disposed along the side edges of the insulating substrate 4. In the protecting device 60 shown in FIG. 17, four base portions 61 are arranged in parallel on the top surface of the upper case 29 and the bottom surface of the lower case 30, respectively, so as to face the blowing member 3, and protruding portions 62 are arranged along the side edges of the insulating substrate 4 where the heat-generator feeding electrode 12 and the heat-generator electrode 14 are formed.

FIG. 17 shows the upper case 29 and lower case 30 of the protecting device 60, in which FIG. 17A is a plan view of the upper case 29, FIG. 17B is a plan view of the lower case 30, FIG. 17C is a cross-sectional view taken along line L-L′ of the upper case 29 shown in FIG. 17A, and FIG. 17D is a cross-sectional view taken along line M-M′ of the lower case 30 shown in FIG. 17B.

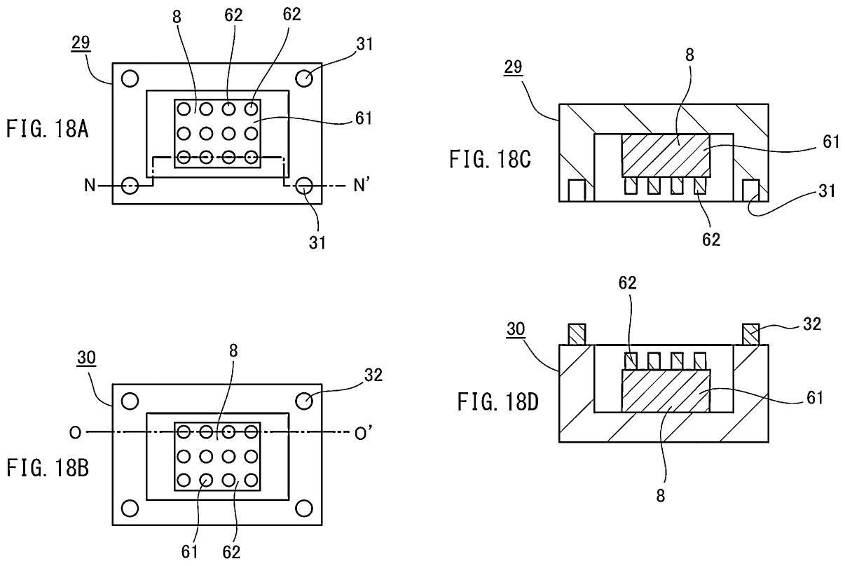

The protecting device 60 may have a plurality of protruding portions 62 evenly arranged on the surface of the base portion 61 in plan view. In the protecting device 60 shown in FIG. 18, the plurality of protruding portions 62 facing the insulating substrate 4 of the blowing member 3 are provided close to the blowing member 3 and come into contact when the blowing member 3 wobbles. The area of the plurality of protruding portions 62 facing the blowing member 3 is set according to the blowing member 3, but it is preferable to cover the entire surface of the insulating substrate 4. The plurality of protruding portions 62 can inhibit the wobbling by contact of one or more of the protruding portions 62 with the blowing member 3. The plurality of protruding portions 62 in contact with the blowing member 3 can stabilize the blowing member 3 and inhibit the wobbling.

FIG. 18 shows the upper case 29 and lower case 30 of the protecting device 60, in which FIG. 18A is a plan view of the upper case 29, FIG. 18B is a plan view of the lower case 30, FIG. 18C is a cross-sectional view taken along line N-N′ of the upper case 29 shown in FIG. 18A, and FIG. 18D is a cross-sectional view taken along line O-O′ of the lower case 30 shown in FIG. 18B.

### Modification 3

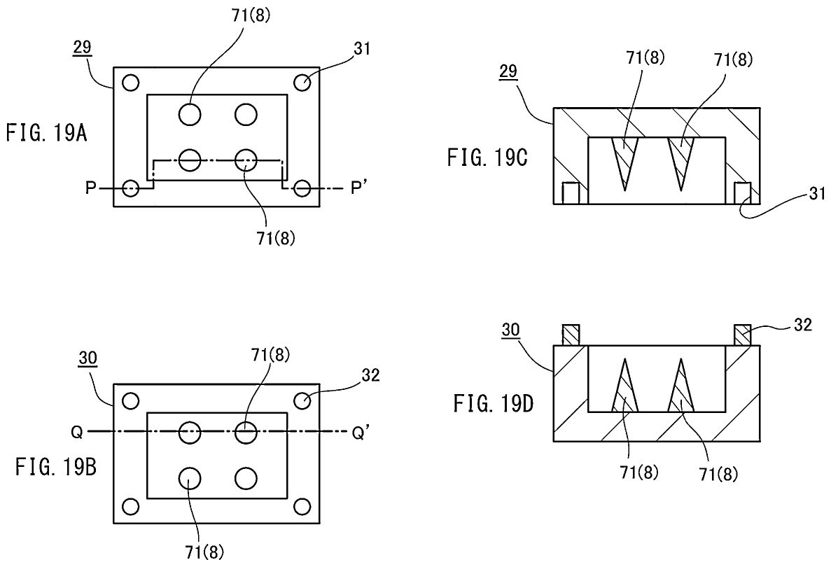

Next, another modification of the fixing member 8 will be described. In the following description as well, the same parts and materials as those of the above-described protecting device 1 are indicated with the same symbols and their details may be omitted. The protecting device 70 shown in FIG. 19 is provided with a conical member 71 as the fixing member 8. The conical member 71 suppresses the wobbling by making point contact with the blowing member 3. By using the conical member 71, the blowing member 3 can be brought into contact with the fixing member 8 by point contact even when a considerable contact area with the fixing member 8 cannot be secured.

FIG. 19 shows the upper case 29 and lower case 30 of the protecting device 70, in which FIG. 19A is a plan view of the upper case 29, FIG. 19B is a plan view of the lower case 30, FIG. 19C is a cross-sectional view taken along line P-P′ of the upper case 29 shown in FIG. 19A, and FIG. 19D is a cross-sectional view taken along line Q-Q′ of the lower case 30 shown in FIG. 19B.

The number of the conical members 71 may be one or more. The conical members 71 may also be arranged to be in contact with the side edge of the insulating substrate 4 opposite to the side edge where the external connection electrode 12a is formed so as to face the external connection electrode 12a as described above, or they may be provided in contact with the four corners of the insulating substrate 4 or along the side edges. In addition to the conical member 71, a pyramidal member may also be used.

### Modification 4

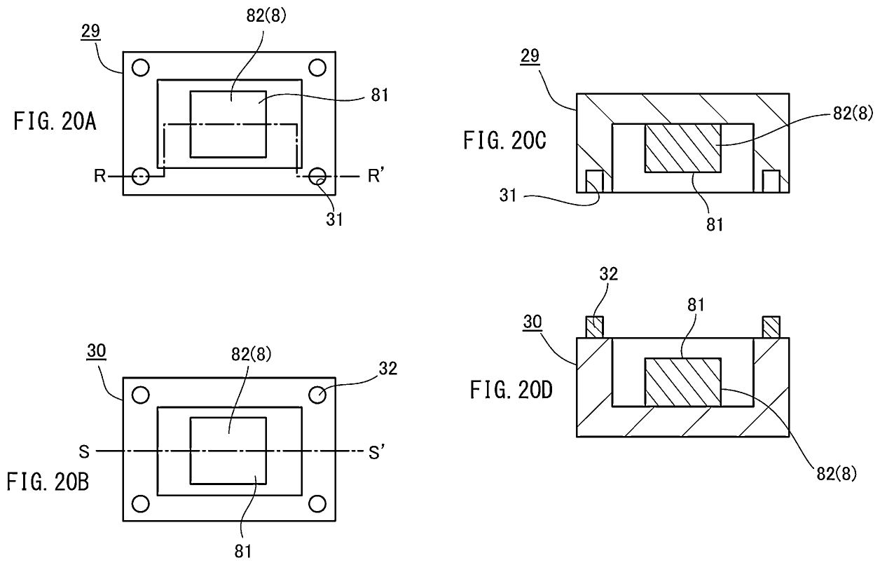

Next, another modification of the fixing member 8 will be described. In the following description as well, the same parts and materials as those of the above-described protecting device 1 are indicated with the same symbols and their details may be omitted. The protecting device 80 shown in FIG. 20 is provided with, as the fixing member 8, a block-shaped member 82 having a supporting surface 81 facing the main surface portion of the insulating substrate 4.

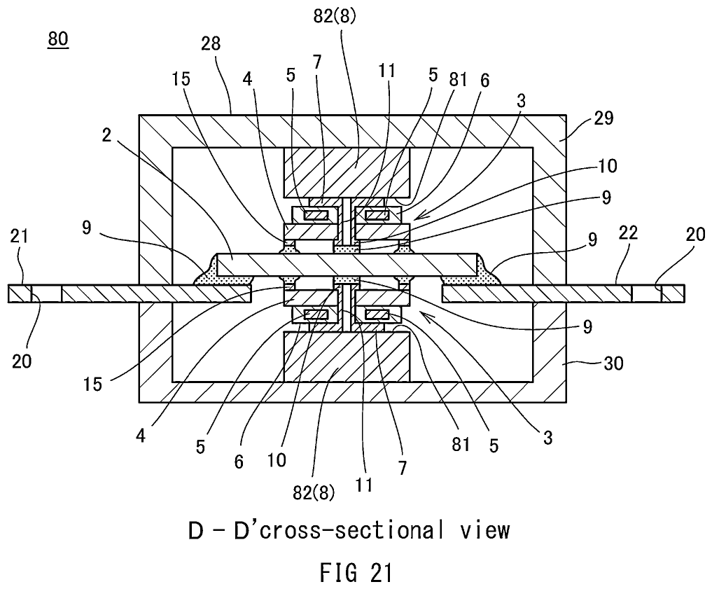

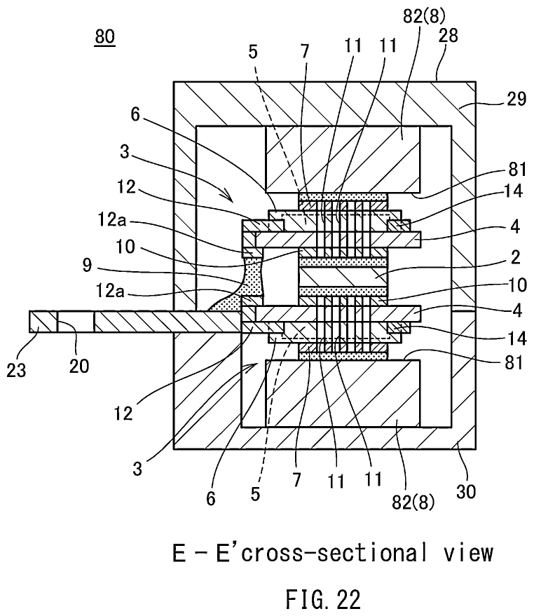

The block-shaped member 82 is provided on the top surface of the upper case 29 and the bottom surface of the lower case 30, respectively, and as shown in FIGS. 21 and 22, the supporting surface 81 facing the insulating substrate 4 of the blowing member 3 contacts the heat-generator lead-out electrode 7 of the blowing member 3. The size of the supporting surface 81 is determined according to the blowing member 3, but the supporting surface 81 preferably has an area larger than the area of the insulating substrate 4. The block-shaped member 82 can stabilize the blowing member 3 by surface contact between the supporting surface 81 and the blowing member 3.

The block-shaped member 82 may have the supporting surface 81 in close proximity to the blowing member 3 so as to contact the blowing member 3 when the blowing member 3 wobbles. When the blowing member 3 wobbles, the block-shaped member 82 can bring the supporting surface 81 into contact with the blowing member 3, thereby restraining the wobbling by surface contact with the supporting surface 81. The block-shaped member 82 can maintain the stabilization of the blowing member 3 after the supporting surface 81 contacts the blowing member 3 by surface contact between the supporting surface 81 and the blowing member 3.

FIG. 20 shows the upper case 29 and lower case 30 of the protecting device 80, in which FIG. 20A is a plan view of the upper case 29, FIG. 20B is a plan view of the lower case 30, FIG. 20C is a cross-sectional view taken along line R-R′ of the upper case 29 shown in FIG. 20A, and FIG. 20D is a cross-sectional view taken along line S-S′ of the lower case 30 shown in FIG. 20B.

The block-shaped member 82 is not limited to a rectangular cross-section but can be formed in any shape, such as a trapezoidal shape or a cylindrical shape.

### Modification 5

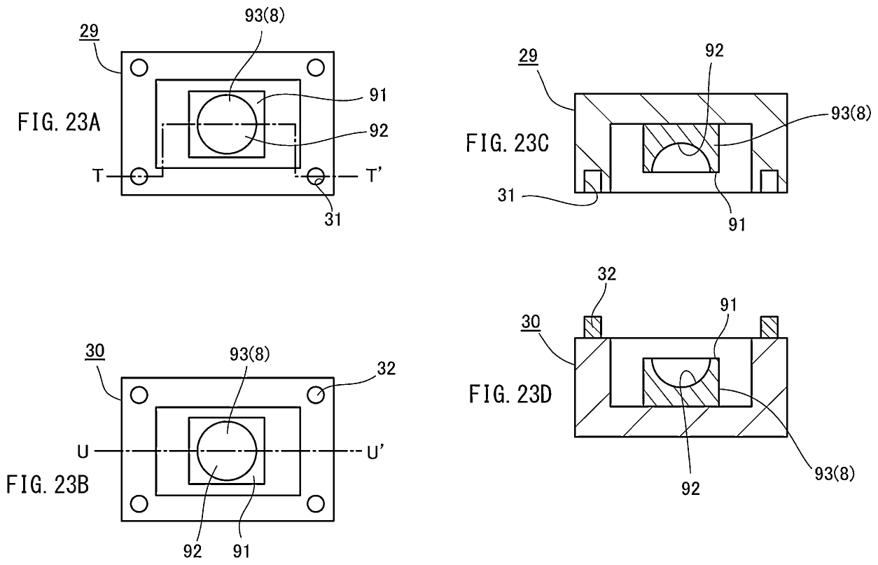

Next, another modification of the fixing member 8 will be described. In the following description as well, the same parts and materials as those of the above-described protecting device 1 are indicated with the same symbols and their details may be omitted. The protecting device 90 shown in FIG. 23 is provided with, as the fixing member 8, a canopy-shaped member 93 having an edge 91 in contact with an outer edge of the insulating substrate 4 and a recess 92 surrounded by the edge 91 and covering a main surface portion of the insulating substrate 4.

The canopy-shaped member 93 is provided on the top surface of the upper case 29 and the bottom surface of the lower case 30, respectively, and the edge 91 facing the insulating substrate 4 of the blowing member 3 is in contact with or close to the insulating substrate 4. The edge 91 may be formed continuously over the entire circumference of the area in contact with the insulating substrate 4 or may be formed intermittently to exclude areas where contact with electrodes, connecting solder, or the like should be avoided. The recess 92 is not limited to a dome shape but can be formed in any shape, such as a rectangular box shape and cylindrical shape, among others. The canopy-shaped member 93 can restrain the blowing member 3 from wobbling when the blowing member 3 is in contact with the edge 91. The canopy-shaped member 93 also does not inhibit the aggregation of the melted conductor 2a by securing the space above the heat-generator lead-out electrode 7 in the recess 92.

FIG. 23 shows the upper case 29 and lower case 30 of the protecting device 90, in which FIG. 23A is a plan view of the upper case 29, FIG. 23B is a plan view of the lower case 30, FIG. 23C is a cross-sectional view taken along line T-T′ of the upper case 29 shown in FIG. 23A, and FIG. 23D is a cross-sectional view taken along line U-U′ of the lower case 30 shown in FIG. 23B.

### Modification 6

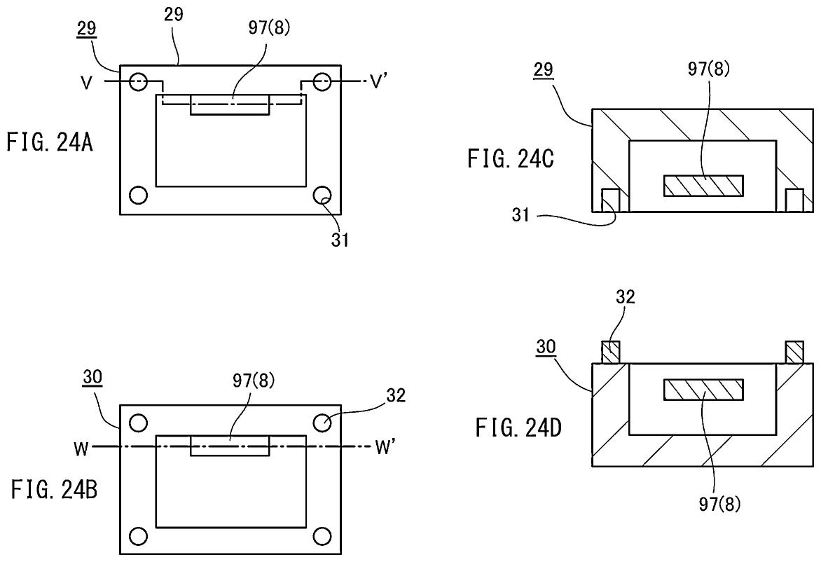

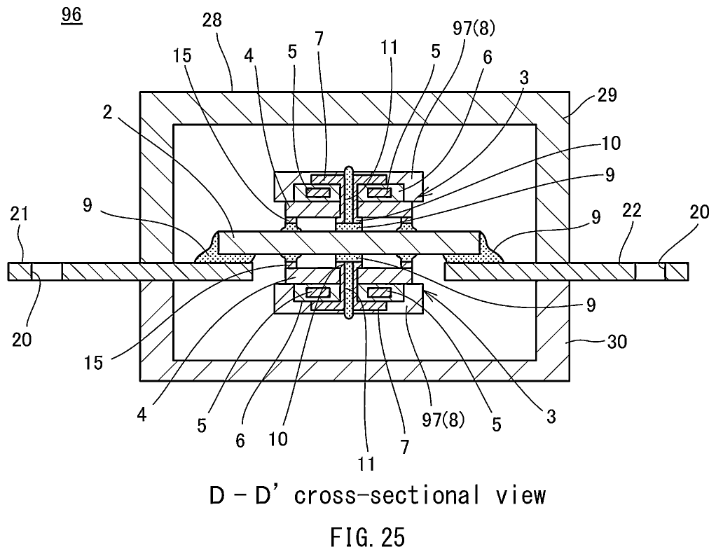

Next, another modification of the fixing member 8 will be described. In the following description as well, the same parts and materials as those of the above-described protecting device 1 are indicated with the same symbols and their details may be omitted. The protecting device 96 shown in FIGS. 24 to 26 is provided with, as the fixing member 8, a supporting piece 97 formed on the inner surface of the case 28 to support the outer edge of the insulating substrate 4.

The supporting piece 97 is formed overhanging the inner surface of the upper case 29 and the inner surface of the lower case 30, respectively, and is provided in contact with the front surface 4a of the insulating substrate 4 opposite to the connecting surface with the fuse element 2 (the back surface 4b). The supporting piece 97 may be integrally molded with the upper and lower cases 29, 30, or it may be formed as a separate member and attached to the upper and lower cases 29, 30.

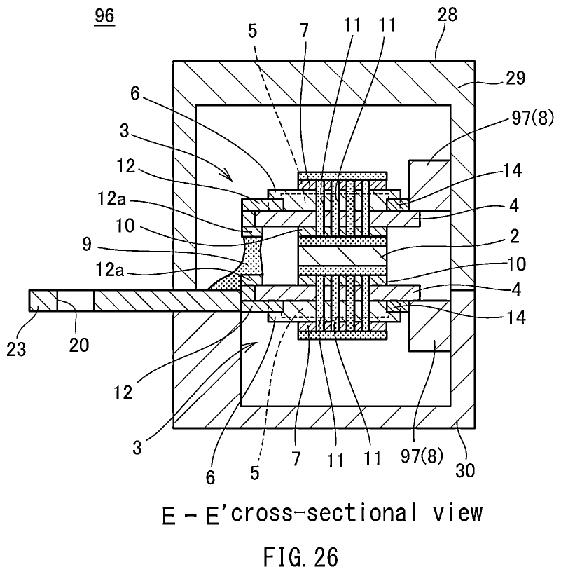

Furthermore, the preferred location for the supporting piece 97 to contact is on a corner of the front surface 4a of the insulating substrate 4 or on the insulating layer 6, among other locations, where it does not interfere with the aggregation of the melted conductor 2a. In particular, as shown in FIG. 26, the supporting piece 97 is preferably provided to contact the side edge of the insulating substrate 4 opposite the side edge where the heat-generator feeding electrode 12 is formed to face the heat-generator feeding electrode 12. This effectively prevents the insulating substrate 4 from tilting toward the external connection electrode 12a. In addition, the supporting piece 97 can stabilize the blowing member 3 by making surface contact with the insulating substrate 4.

The supporting piece 97 may be provided in close proximity to the front surface 4a of the insulating substrate 4 to contact the blowing member 3 when the blowing member 3 wobbles. When the blowing member 3 wobbles, the supporting piece 97 contacts the insulating substrate 4 so that the supporting piece 97 and the insulating substrate 4 make a surface contact to restrain the wobbling. In addition, the supporting piece 97 can maintain the stabilization of the insulating substrate 4 after contacting the insulating substrate 4 by surface contact with the insulating substrate 4.

A plurality of supporting pieces 97 may be provided in the upper and lower cases 29, 30, respectively, to support different side edges of the insulating substrate 4.

FIG. 24 shows the upper case 29 and lower case 30 of the protecting device 96, in which FIG. 24A is a plan view of the upper case 29, FIG. 24B is a plan view of the lower case 30, FIG. 24C is a cross-sectional view taken along line V-V′ of the upper case 29 shown in FIG. 24A, and FIG. 24D is a cross-sectional view taken along line W-W′ of the lower case 30 shown in FIG. 24B.

Although the above-described protecting devices all have the blowing member 3 connected to both sides of the fuse element 2, the protecting device according to the present technology may have the blowing member 3 connected to only one side of the fuse element 2.

In all of the above-described protecting devices, the back surface 4b of the insulating substrate 4 is the connecting surface to the fuse element 2, and the front surface 4a is the contacting surface with the fixing member 8; however, in the protecting device according to the present technology, the front surface 4a of the insulating substrate 4 may be the connecting surface to the fuse element 2, and the back surface 4b may be the contacting surface with the fixing member 8. In this case, the heat-generator lead-out electrode 7 is connected to the fuse element 2 by means of the connecting solder 9.

### REFERENCE SIGNS LIST

1 protecting device, 2 fuse element, 2a melted conductor, 3 blowing member, 4 insulating substrate, 4a front surface, 4b back surface, 5 heat generator, 6 insulating layer, 7 heat-generator lead-out electrode, 7a tip portion, 7b base portion, 8 fixing member, 9 connecting solder, 10 holding electrode, 11 through-hole, 12 heat-generator feeding electrode, 12a external connection electrode, 14 heat-generator electrode, 15 auxiliary electrode, 17 columnar member, 21 first electrode terminal, 22 second electrode terminal, 23 third electrode terminal, 24 conductive layer, 26 low-melting-point metal layer, 27 high-melting-point metal layer, 28 case, 29 upper case, 30 lower case, 30a side edge portion, 30b hollow portion, 40 battery pack, 41 battery cell, 42 charging device, 43 current control element, 44 control unit, 45 battery stack, 46 charge/discharge control 5 circuit, 47 detection circuit, 48 current control element, 50 protecting device, 60 protecting device, 61 base portion, 62 protruding portion, 70 protecting device, 71 conical member, 80 protecting device, 81 supporting surface, 82 block-shaped member, 90 protecting device, 91 edge, 92 recess, 93 canopy-shaped member, 96 protecting device, 97 supporting piece

1. A protecting device, comprising:
a case;
a fuse element;
a blowing member connected to at least one side of the fuse element to blow the fuse element; and
a fixing member provided on an inner surface of the case and in contact with the blowing member to restrain the wobbling of the blowing member, wherein
the blowing member comprises an insulating substrate and a heat generator formed on the insulating substrate, and the insulating substrate is connected to the fuse element by a bonding material that is softened by the heat generated by the heat generator.

2. The protecting device according to claim 1, wherein
the blowing member is connected to the one side and the other side of the fuse element, and
a plurality of the fixing members are provided to restrain the wobbling of each of the blowing members connected to the one side and the other side of the fuse element.

3. The protecting device according to claim 2, wherein the blowing members are connected at opposite positions via the fuse element.

4. The protecting device according to claim 1, wherein the fixing member is a separate member that is separate from the case and is adhered to the inner surface of the case.

5. The protecting device according to claim 1, wherein the fixing member is integrally molded with the case.

6. The protecting device according to claim 1, wherein the fixing member is provided in close proximity to the blowing member.

7. The protecting device according to claim 1, wherein the fixing member is provided in contact with the blowing member.

8. The protecting device according to claim 1, wherein the fixing member is provided with an interface material at the part in contact with the blowing member.

9. The protecting device according to claim 1, wherein the fixing member comprises one or more columnar members.

10. The protecting device according to claim 1, wherein the fixing member includes a base portion formed on the inner front surface of the case and a plurality of protruding portions protruding from the base portion toward the insulating substrate of the blowing member.

11. The protecting device according to claim 10, wherein the protruding portions are evenly distributed on the surface of the base portion in plan view.

12. The protecting device according to claim 1, wherein the fixing member comprises one or more conical or pyramidal members.

13. The protecting device according to claim 1, wherein the fixing member comprises a block-shaped member having a supporting surface facing a main surface portion of the insulating substrate.

14. The protecting device according to claim 13, wherein the supporting surface has an area equal to or greater than the area of the insulating substrate.

15. The protecting device according to claim 1, wherein the fixing member comprises a canopy-shaped member having an edge portion in contact with an outer edge portion of the insulating substrate and a recess surrounded by the edge portion and covering the main surface portion of the insulating substrate.

16. The protecting device according to claim 1, wherein the fixing member comprises a supporting piece provided on an inner surface of the case and supporting the outer edge portion of the insulating substrate.

17. A battery pack, comprising:
one or more battery cells; and a protecting device connected to a charging/discharging path of the battery cell to interrupt the charging/discharging path, wherein
the protecting device is the protecting device according to claim 1.
